(19) United States
(12) Patent Application Publication
(10) Pub. No.: US 2026/0141487 A1
(43) Pub. Date: May 21, 2026

(54) IMAGE PROCESSING APPARATUS, METHOD, AND PROGRAM

(71) Applicant: FUJIFILM Corporation, Tokyo (JP)

(72) Inventor: Shuhei HORITA, Saitama (JP)

(73) Assignee: FUJIFILM Corporation, Tokyo (JP)

(21) Appl. No.: 19/452,885

(22) Filed: Jan. 20, 2026

Related U.S. Application Data
(63) Continuation of application No. PCT/JP2024/021830, filed on Jun. 17, 2024.

(30) Foreign Application Priority Data
Jul. 28, 2023 (JP) 2023-123698

(51) Int. Cl. G06T 5/50; G06T 5/80; G06T 7/00; G06T 7/60

(52) U.S. Cl. CPC G06T 5/50; G06T 5/80; G06T 7/0002; G06T 7/60; G06T 2207/20221; G06T 2207/30168

(57) ABSTRACT

Provided are an image processing apparatus, method, and program that can generate an image that is effective for understanding an outline of an object even in a case in which a normal composite image cannot be generated. The image processing apparatus includes a processor. The processor acquires an image group and information about an imaging position of images constituting the image group, performs a first composition process on the image group to generate a first composite image, determines whether a quality of the first composite image satisfies a first criterion, and performs, in a case in which the quality of the first composite image does not satisfy the first criterion, a second composition process on the image group or the first composite image based on the information about the imaging position to generate a second composite image.

### CROSS-REFERENCE TO RELATED APPLICATIONS

The present application is a Continuation of PCT International Application No. PCT/JP2024/021830 filed on June 17, 2024 claiming priority under 35 U.S.C §119(a) to Japanese Patent Application No. 2023-123698 filed on July 28, 2023. Each of the above applications is hereby expressly incorporated by reference, in its entirety, into the present application.

### BACKGROUND OF THE INVENTION

### 1. Field of the Invention

The present invention relates to an image processing apparatus, method, and program, and more particularly to an image processing apparatus, method, and program for joining a plurality of images together to generate a single composite image.

### 2. Description of the Related Art

Stitching is known as a technology for generating a single image that captures a wide range. In stitching, a target is divided into a plurality of parts and imaged, and a plurality of obtained images are joined together to generate a single composite image (for example, JP2023-7662A, JP2005-30961A, JP2003-111073A, JP2002-188998A, and the like).

### SUMMARY OF THE INVENTION

One embodiment of the technology of the present disclosure provides an image processing apparatus, method, and program that can generate an image that is effective for understanding an outline of an object even in a case in which a normal composite image cannot be generated.

(1) An image processing apparatus comprising a processor, in which the processor is configured to acquire an image group and information about an imaging position of images constituting the image group, perform a first composition process on the image group to generate a first composite image, determine whether a quality of the first composite image satisfies a first criterion, and perform, in a case in which the quality of the first composite image does not satisfy the first criterion, a second composition process on the image group or the first composite image based on the information about the imaging position to generate a second composite image.

(2) The image processing apparatus according to (1), in which the processor is configured to perform, as the first composition process, a process of performing feature point matching between the images constituting the image group and generating the first composite image from a result of the feature point matching.

(3) The image processing apparatus according to (1) or (2), in which the processor is configured to determine a degree of fragmentation of the first composite image to determine whether the quality of the first composite image satisfies the first criterion.

(4) The image processing apparatus according to (3), in which the processor is configured to perform, as the second composition process, a process of disposing at least some of a plurality of fragments of the first composite image on fragments different from the fragments based on the information about the imaging position to composite the fragments, and generate, as the second composite image, an image having a lower degree of fragmentation than the first composite image.

(5) The image processing apparatus according to (4), in which the processor is configured to further perform a process of extracting, from the plurality of fragments, a fragment having distortion exceeding a predetermined range, and correcting the distortion of the extracted fragment having the distortion, before performing the second composition process.

(6) The image processing apparatus according to any one of (1) to (5), in which the processor is configured to determine whether a quality of the second composite image satisfies a second criterion, and generate, in a case in which the quality of the second composite image does not satisfy the second criterion, as the second composite image, an image obtained by disposing the images constituting the image group based on the information about the imaging position.

(7) The image processing apparatus according to any one of (1) to (6), in which the processor is configured to determine whether a degree of distortion of at least the first composite image is within an allowable range to determine whether the quality of the first composite image satisfies the first criterion.

(8) The image processing apparatus according to (7), in which the processor is configured to perform, as the second composition process, a process of disposing the images constituting the image group based on the information about the imaging position to generate the second composite image.

(9) The image processing apparatus according to (7) or (8), in which the processor is configured to measure a maximum value and a minimum value of a width of the first composite image in a first direction, calculate a difference between the maximum value and the minimum value of the width in the first direction, and determine whether the difference is equal to or less than a threshold value to determine whether the degree of distortion of the first composite image is within the allowable range.

(10) The image processing apparatus according to any one of (7) to (9), in which the processor is configured to acquire information about an imaging condition of the images constituting the image group, estimate a width of the first composite image in a second direction based on the information about the imaging condition, measure the width of the first composite image in the second direction, calculate a difference between an estimated value and a measured value of the width in the second direction, and determine whether the difference is equal to or less than a threshold value to determine whether the degree of distortion of the first composite image is within the allowable range.

(11) The image processing apparatus according to any one of (7) to (10), in which the processor is configured to calculate a deviation degree of composition parameters determined from a result of the feature point matching between adjacent images, and determine whether there is an image for which the deviation degree is equal to or greater than a threshold value to determine whether the degree of distortion of the first composite image is within the allowable range.

(12) The image processing apparatus according to any one of (1) to (11), in which the processor is configured to perform the feature point matching between adjacent images based on the information about the imaging position.

(13) The image processing apparatus according to any one of (1) to (12), in which the image group includes images captured at different positions using an imaging apparatus equipped with a plurality of cameras, and the information about the imaging position includes information about disposition positions of the cameras in the imaging apparatus and information about positions where imaging is performed by the imaging apparatus.

(14) The image processing apparatus according to any one of (1) to (13), in which the processor is configured to acquire, for an object divided into a plurality of sections in a longitudinal direction, the image group and the information about the imaging position of the images constituting the image group for each section, generate the first composite image or the second composite image for each section, and generate a first output image in which the first composite image or the second composite image generated for each section is disposed based on arrangement of the sections.

(15) The image processing apparatus according to any one of (1) to (14), in which the processor is configured to analyze the images constituting the image group, the first composite image, or the second composite image to detect damage to a surface of an object, and generate a second output image in which detection results of the damage are superimposed on the first composite image or on the second composite image.

(16) An image processing method comprising: acquiring an image group and information about an imaging position of images constituting the image group; performing a first composition process on the image group to generate a first composite image; determining whether a quality of the first composite image satisfies a first criterion; and performing, in a case in which the quality of the first composite image does not satisfy the first criterion, a second composition process on the image group or the first composite image based on the information about the imaging position to generate a second composite image.

(17) An image processing program causing a computer to implement: a function of acquiring an image group and information about an imaging position of images constituting the image group; a function of performing a first composition process on the image group to generate a first composite image; a function of determining whether a quality of the first composite image satisfies a first criterion; and a function of performing, in a case in which the quality of the first composite image does not satisfy the first criterion, a second composition process on the image group or the first composite image based on the information about the imaging position to generate a second composite image.

### BRIEF DESCRIPTION OF THE DRAWINGS

FIG. 1 is a diagram showing a schematic configuration of an imaging system.

FIG. 2 is a perspective view showing a configuration of a multi-eye imaging apparatus.

FIG. 3 is a front view showing the configuration of the multi-eye imaging apparatus.

FIG. 4 is a rear view showing the configuration of the multi-eye imaging apparatus.

FIG. 5 is a block diagram showing an electric configuration of the multi-eye imaging apparatus.

FIG. 6 is a diagram showing an example of a hardware configuration of a control device.

FIG. 7 is a functional block diagram of an imaging control function of the control device.

FIG. 8 is a block diagram of main functions of a camera control unit.

FIG. 9 is a diagram showing an example of a live view display.

FIG. 10 is a functional block diagram of an image processing function of the control device.

FIG. 11 is a conceptual diagram of a composition process using feature point matching.

FIG. 12 is a diagram showing an example of a fragmented composite image.

FIG. 13 is a diagram showing an example of a composite image in which distortion has occurred.

FIG. 14 is a diagram showing an example of a composite image in which distortion has occurred.

FIG. 15 is a conceptual diagram of a composition process in a second composition processing unit.

FIG. 16 is a diagram showing an example of a composite result.

FIG. 17 is a conceptual diagram of generation of a composite image by a third composite processing unit.

FIG. 18 is a diagram showing an example of the composite image generated by the third composition processing unit.

FIG. 19 is a flowchart showing a procedure of a process of generating a composite image.

FIG. 20 is a conceptual diagram of a method for specifying images that have been captured in an overlapping manner.

FIG. 21 is a diagram showing an example of a primary image that is fragmented in a distorted state.

FIG. 22 is a functional block diagram showing an example of a case in which a secondary composite image is generated by correcting distortion.

FIG. 23 is a diagram showing an example of a case in which a secondary composite image is generated by performing distortion correction.

FIG. 24 is a diagram showing an example of a display of a composite result in a case in which a composite image is generated by dividing the image into a plurality of sections.

FIG. 25 is a diagram showing an example of a case in which the entire image is enlarged and displayed.

FIG. 26 is a diagram showing an example of a display of a detection result of damage.

FIG. 27 is a diagram showing an example of a case in which an object is imaged with one camera.

### DESCRIPTION OF THE PREFERRED EMBODIMENTS

Hereinafter, a preferred embodiment of the present invention will be described in detail with reference to the accompanying drawings.

Here, as a composition process using stitching, a case in which composition is performed by so-called feature point matching (corresponding point search) will be described as an example.

In composition using feature point matching, feature points are extracted from each image, similar feature points are matched, composition parameters are generated from the correspondence relationship, and the images are composited. Therefore, in a case in which there are gaps or omissions in the imaging, a case in which there is insufficient overlap between adjacent images, or a case in which the images are blurred or out of focus, the composition may fail. These are caused by the imaging, but there are also cases in which composition fails due to the imaging target (the subject). For example, in a case in which the surface is very uneven and the shadows or shapes captured change depending on the imaging position, it may not be possible to match the feature points, and composition may fail. Furthermore, in a case in which the shape of the imaging target deviates significantly from the assumed shape model, this can also be a cause of composition failure. In a case in which the composition fails, an image is fragmented or a significantly distorted image is generated. “The image is fragmented” means that the image is generated by dividing the image into a plurality of parts.

In a case in which the composition fails, re-imaging is required to obtain a normal composite image. However, depending on the object, it may be difficult to re-image the object. On the other hand, depending on the application, it may be sufficient to understand the outline of the object.

The present embodiment aims to provide an image processing apparatus that can generate an image that is effective for understanding the outline of an object even in a case in which a normal composite image cannot be generated.

### Imaging System

Here, a case in which the present invention is applied to an imaging system used for inspecting tunnel structures will be described as an example.

Water diversion channels of hydroelectric power facilities, tunnel structures such as subway tunnel, and the like are regularly inspected in order to ensure their safety. In recent years, visual inspection has been replaced by image inspection. Image inspection is performed by capturing a wall surface of the tunnel structure with a camera and detecting damage such as fissuring from the obtained image through visual observation or image processing.

The imaging is performed by dividing the region to be imaged into a plurality of parts (so-called divided imaging). Furthermore, in order to generate a composite image (a so-called panorama composite image) from the captured images, each image is captured with a portion of each image overlapping adjacent images.

### Configuration of Imaging System

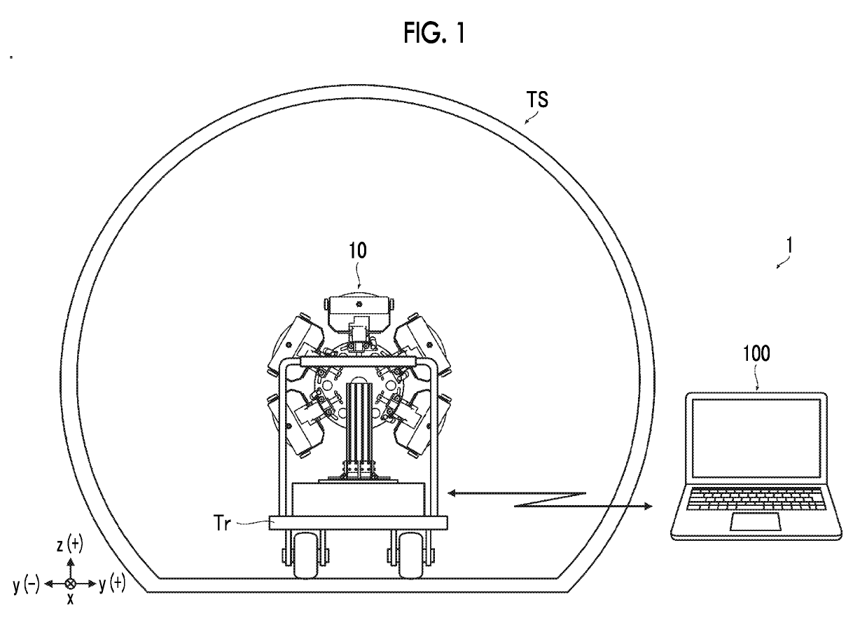

FIG. 1 is a diagram showing a schematic configuration of an imaging system.

As described above, an imaging system 1 according to the present embodiment is configured as a system that images an inner wall surface of a tunnel structure TS. The tunnel structure TS, which is an object (subject) to be imaged, has an arc-shaped cross section (semicircular).

As shown in FIG. 1, the imaging system 1 according to the present embodiment comprises a multi-eye imaging apparatus 10 that images an inner wall surface of a tunnel structure TS by using a plurality of cameras, and a control device 100 that controls the multi-eye imaging apparatus 10 and processes an image captured by the multi-eye imaging apparatus 10.

The multi-eye imaging apparatus 10 is mounted on, for example, a carriage Tr, and captures images while moving within the tunnel structure TS (captures images while changing its position). The carriage Tr is provided with an electric assist function (a function that assists human power with an electric motor) as necessary.

### Multi-Eye Imaging Apparatus

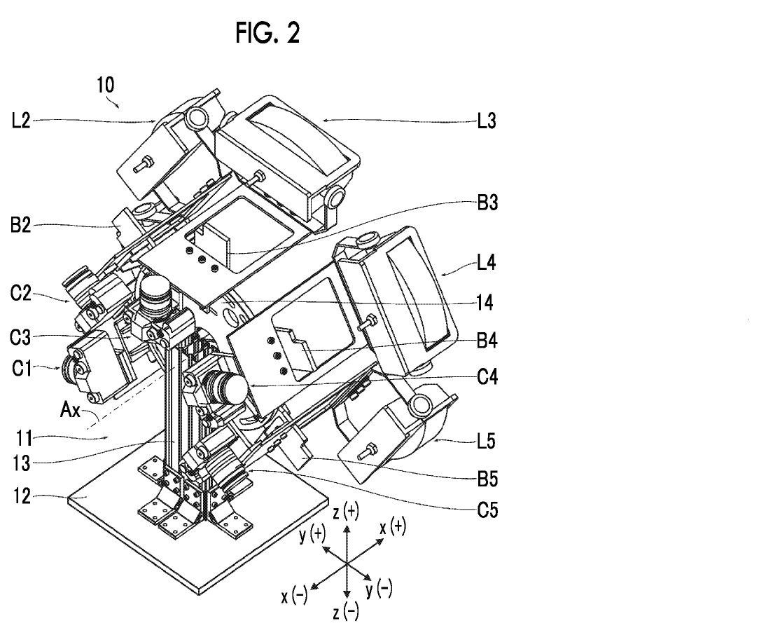

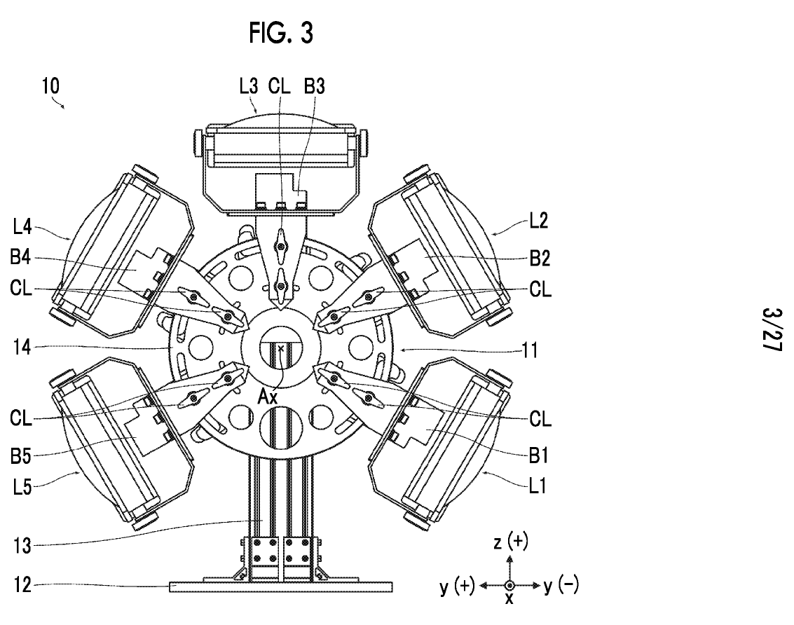

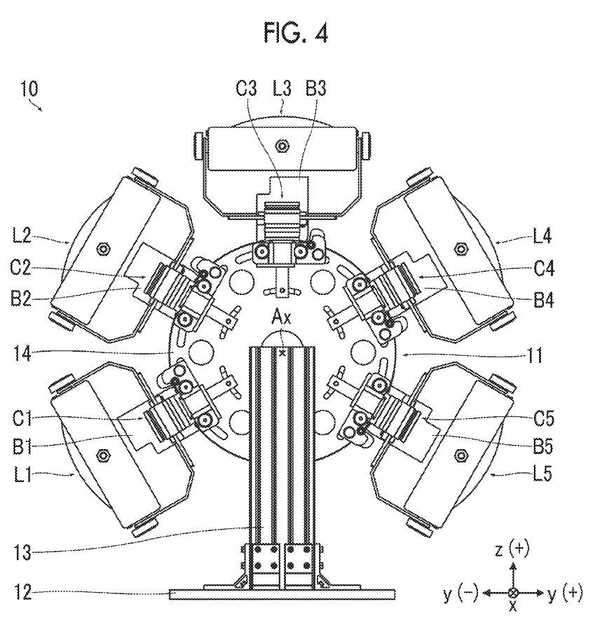

FIG. 2 is a perspective view showing a configuration of the multi-eye imaging apparatus. FIG. 3 is a rear view showing a configuration of the multi-eye imaging apparatus. FIG. 4 is a side view showing the configuration of the multi-eye imaging apparatus. In FIGS. 2 to 4, the x-axis, the y-axis, and the z-axis are three axes orthogonal to each other. A plane including the x-axis and the y-axis is defined as a horizontal plane, and a direction of the z-axis is defined as a vertical direction. In addition, a direction of the x-axis is set as a traveling direction of the carriage Tr, and a + direction of the x-axis is set as a progressing direction at the time of imaging. Therefore, the + direction of the x-axis is the front direction (forward direction) of the carriage Tr and the multi-eye imaging apparatus 10, and the - direction is the rear direction (rearward direction) of the carriage Tr and the multi-eye imaging apparatus 10.

The multi-eye imaging apparatus 10 is configured using a plurality of cameras and a plurality of illumination devices. The numbers of cameras and illumination devices are appropriately increased or decreased according to the imaging target. Here, a case in which the multi-eye imaging apparatus 10 is configured using five cameras C1 to C5 and five illumination devices L1 to L5 will be described as an example.

The multi-eye imaging apparatus 10 has a frame 11 for attaching a plurality of cameras C1 to C5 and a plurality of illumination devices L1 to L5.

The frame 11 is mainly configured with a flat base plate 12, a rectangular column 13 installed on the base plate 12, and a disk-shaped attachment base 14 attached to the column 13. The base plate 12 functions as an installation portion on the carriage Tr. The column 13 and the attachment base 14 are installed perpendicular to the base plate 12. An axis Ax that passes through the center of the attachment base 14 and is parallel to the x-axis is defined as the axis of the multi-eye imaging apparatus 10.

The cameras C1 to C5 and the illumination devices L1 to L5 are attached to the attachment base 14 via brackets B1 to B5. Hereinafter, as necessary, the cameras C1 to C5 will be distinguished from one another by referring to the camera C1 as a “first camera C1”, the camera C2 as a “second camera C2”, the camera C3 as a “third camera C3”, the camera C4 as a “fourth camera C4”, and the camera C5 as a “fifth camera C5”.

Furthermore, the illumination devices L1 to L5 will be distinguished from one another by referring to the illumination device L1 as a “first illumination device L1”, the illumination device L2 as a “second illumination device L2”, the illumination device L3 as a “third illumination device L3”, the illumination device L4 as a “fourth illumination device L4”, and the illumination device L5 as a “fifth illumination device L5”.

Furthermore, the brackets B1 to B5 will be distinguished from one another by referring to the bracket B1 as a “first bracket B1”, the bracket B2 as a “second bracket B2”, the bracket B3 as a “third bracket B3”, the bracket B4 as a “fourth bracket B4”, and the bracket B5 as a “fifth bracket B5”.

The first camera C1 and the first illumination device L1 are attached to the attachment base 14 via the first bracket B1. The second camera C2 and the second illumination device L2 are attached to the attachment base 14 via the second bracket B2. The third camera C3 and the third illumination device L3 are attached to the attachment base 14 via the third bracket B3. The fourth camera C4 and the fourth illumination device L4 are attached to the attachment base 14 via the fourth bracket B4. The fifth camera C5 and the fifth illumination device L5 are attached to the attachment base 14 via the fifth bracket B5.

The brackets B1 to B5 are disposed on the same circumference with the axis Ax as the center with respect to the attachment base 14. Each of the brackets B1 to B5 is attached to the attachment base 14 to be movable around the axis Ax within a predetermined angular range (for example, 30°) in the circumferential direction. Each of the brackets B1 to B5 is fixed to the attachment base 14 by a clamp (for example, a toggle clamp) CL. Therefore, the disposition position of each of the brackets B1 to B5 in the circumferential direction can be adjusted by loosening the clamp CL.

The cameras C1 to C5 are mounted on camera mounting portions provided on the brackets B1 to B5. The illumination devices L1 to L5 are mounted on illumination mounting portions provided on the brackets B1 to B5. Each of the cameras C1 to C5 is attached to the camera mounting portion using, for example, a screw hole for a tripod. Each of the illumination devices L1 to L5 is attached to the illumination mounting portion by fixing the arm portion with a bolt.

The cameras C1 to C5 and the illumination devices L1 to L5 are attached to the attachment base 14 via the brackets B1 to B5 and are disposed on the frame 11 in a predetermined posture. Specifically, the cameras C1 to C5 and the illumination devices L1 to L5 are disposed in a plane (in a zy plane) orthogonal to the axis Ax of the multi-eye imaging apparatus 10, facing outward in a radial direction (normal direction) centered on the axis Ax of the multi-eye imaging apparatus 10. More specifically, the cameras C1 to C5 are disposed such that imaging optical axes thereof are directed outward in the radial direction (normal direction) centered on the axis Ax of the multi-eye imaging apparatus 10. In addition, bottom surfaces of camera bodies of the cameras C1 to C5 are attached in parallel with the attachment base 14 (in parallel with the zy plane) (a bottom side of an image sensor is attached in parallel with the zy plane). Accordingly, each of the cameras C1 to C5 is disposed at a predetermined interval in the circumferential direction in the zy plane about the axis Ax of the multi-eye imaging apparatus 10. The illumination devices L1 to L5 are disposed such that irradiation directions thereof are directed outward in the radial direction (normal direction) centered on the axis Ax of the multi-eye imaging apparatus 10. As a result, the cameras C1 to C5 and the illumination devices L1 to L5 are radially disposed in the zy plane about the axis Ax of the multi-eye imaging apparatus 10.

As described above, the brackets B1 to B5 are attached to be movable within a predetermined angular range in the circumferential direction around the axis Ax of the multi-eye imaging apparatus 10. FIGS. 3 and 4 show a state in which each of the brackets B1 to B5 is fixed at a reference position. By fixing each of the brackets B1 to B5 at the reference position, the first camera C1 and the first illumination device L1 are disposed at positions of 330° (-30°) in a front view (FIG. 3). The second camera C2 and the second illumination device L2 are disposed at a position of 30°. The third camera C3 and the third illumination device L3 are disposed at a position of 90°. The fourth camera C4 and the fourth illumination device L4 are disposed at a position of 150°. The fifth camera C5 and the fifth illumination device L5 are disposed at a position of 210°.

Each of the brackets B1 to B5 is attached to be movable in a range of ±15° in the circumferential direction from the reference position. Therefore, the disposition position of each of the cameras C1 to C5 and the illumination devices L1 to L5 can be adjusted in a range of ±15° in the circumferential direction from the reference position.

In the multi-eye imaging apparatus 10 configured as described above, the five cameras C1 to C5 and the five illumination devices L1 to L5 are disposed on a circumference about on the axis Ax of the apparatus. The disposition positions of the cameras C1 to C5 are adjusted such that the imaging regions of adjacent cameras overlap. In this case, it is preferable to adjust the disposition positions of the cameras C1 to C5 such that an overlap rate of at least 10% or more is ensured. The overlap rate refers to the rate at which the imaging regions of adjacent cameras overlap (the rate at which the captured images overlap).

The cameras C1 to C5 used are digital cameras. The type of digital cameras is not particularly limited. It is sufficient that it has the function of electrically recording images (still images or moving images). For example, a lens-interchangeable digital camera is used. In the present embodiment, the cameras C1 to C5 have a storage (storage medium) and store captured images in the storage. The storage may be a built-in memory or an interchangeable memory card.

The illumination devices L1 to L5 to be used are not particularly limited. As an example, a halogen lamp is used. In addition, for example, a light-emitting diode (LED) lamp, a xenon lamp, or the like can be used. In the present embodiment, an illumination device having a function of adjusting an irradiation angle (irradiation direction) is used. Each of the illumination devices L1 to L5 is rotated (swivels in the front-rear direction) about an axis orthogonal to the optical axes of the cameras C1 to C5, and the irradiation angle (irradiation direction) is adjusted. Each of the illumination devices L1 to L5 has an irradiation range that can cover the imaging range of the corresponding cameras C1 to C5.

### Electric Configuration of Multi-Eye Imaging Apparatus

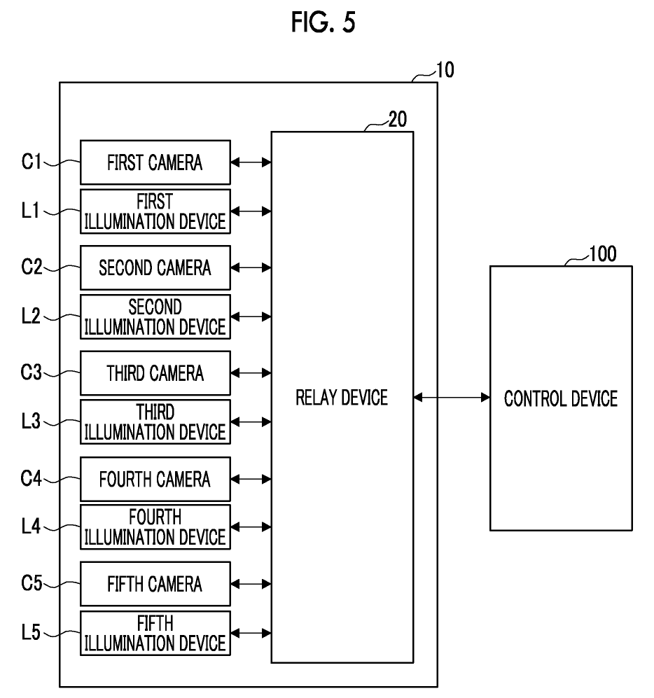

FIG. 5 is a block diagram showing an electric configuration of the multi-eye imaging apparatus.

As shown in FIG. 5, the multi-eye imaging apparatus 10 includes a relay device 20 and is communicatively connected to the control device 100 via the relay device 20.

The relay device 20 is configured by, for example, a computer having a communication function. Each of the cameras C1 to C5 and the illumination devices L1 to L5 is connected to the relay device 20. The connection form between each of the cameras C1 to C5 and the relay device 20 is not particularly limited. The connection may be made in a wired communicable manner or in a wireless communicable manner.

The form of communication between the control device 100 and the relay device 20 is also not particularly limited. The communication may be wired communication or wireless communication. As an example, in the present embodiment, the control device 100 and the relay device 20 are connected via a wireless local area network (LAN).

### Control Device

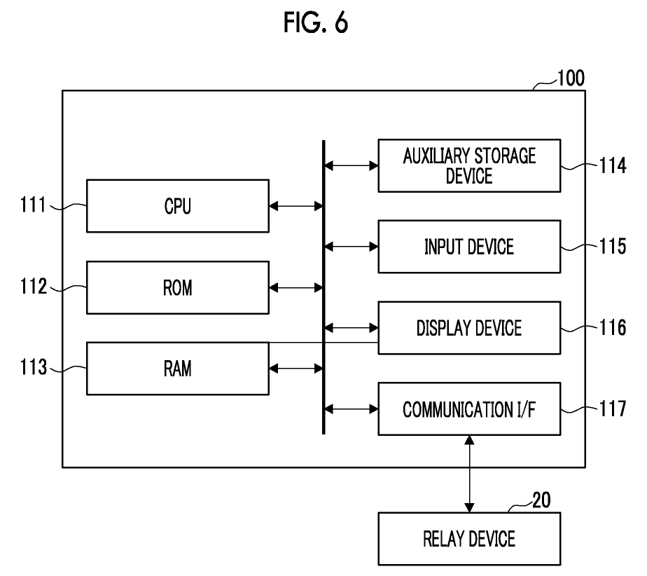

FIG. 6 is a diagram showing an example of a hardware configuration of the control device.

As shown in FIG. 6, the control device 100 comprises a central processing unit (CPU) 111, a read-only memory (ROM) 112, a random-access memory (RAM) 113, an auxiliary storage device 114, an input device 115, a display device 116, a communication interface (I/F) 117, and the like. In general, this type of configuration can be implemented by a computer. As an example, in the present embodiment, the control device 100 is configured as a notebook personal computer. The control device 100 is an example of a processing device.

The control device 100 functions as a control device by the CPU 111, which is a processor, executing a predetermined program. The program executed by the CPU 111 is stored in the ROM 112 or the auxiliary storage device 114.

The auxiliary storage device 114 constitutes a storage unit of the control device 100. The auxiliary storage device 114 is configured by, for example, a hard disk drive (HDD), a solid-state drive (SSD), or the like.

The input device 115 constitutes an operation unit of the control device 100. The input device 115 is configured by, for example, a keyboard, a mouse, a touch panel, and the like.

The display device 116 constitutes a display unit of the control device 100. The display device 116 is configured by for example, a liquid crystal display (LCD), an organic light-emitting diode (OLED) display, or the like.

The communication interface 117 constitutes a communication unit of the control device 100. The communication interface 117 is configured to be capable of communicating with at least the relay device 20 using a predetermined communication scheme. As an example, in the present embodiment, communication via a wireless LAN is possible.

### Function of Control Device

The control device 100 has a function of controlling the multi-eye imaging apparatus 10 and a function of processing an image captured by the multi-eye imaging apparatus 10 (image processing function). The function of controlling the multi-eye imaging apparatus 10 includes a function of controlling the imaging performed by the multi-eye imaging apparatus 10 (imaging control function).

### Imaging Control Function

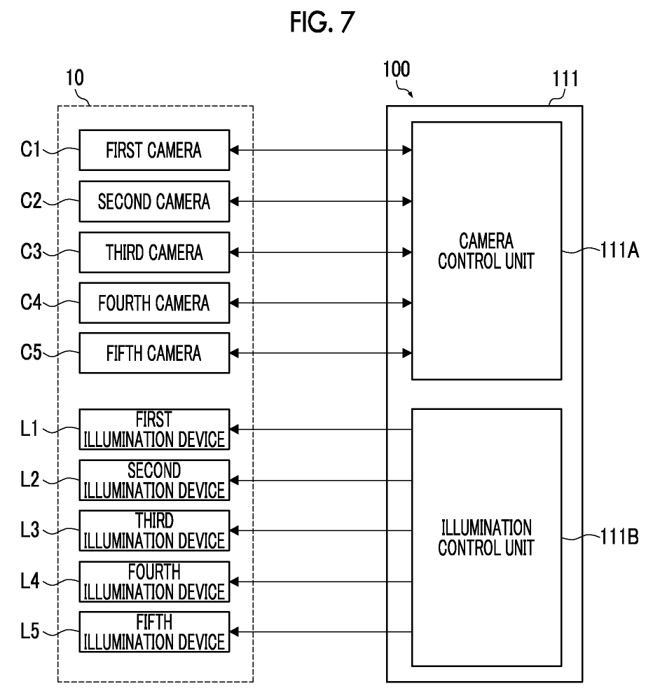

FIG. 7 is a functional block diagram of an imaging control function of the control device.

As shown in FIG. 7, the control device 100 has, as an imaging control function, functions of a camera control unit 111A, an illumination control unit 111B, and the like. The functions of the camera control unit 111A and the illumination control unit 111B are implemented by the CPU 111 executing a predetermined program.

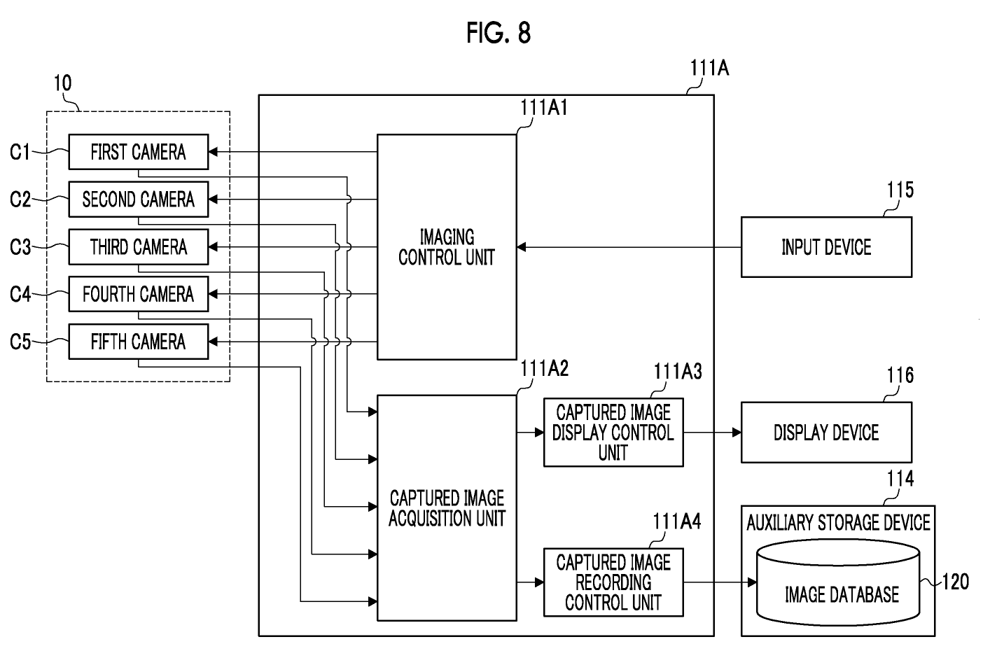

FIG. 8 is a block diagram of main functions of the camera control unit.

As shown in FIG. 8, the camera control unit 111A mainly has the functions of an imaging control unit 111A1, a captured image acquisition unit 111A2, a captured image display control unit 111A3, and a captured image recording control unit 111A4.

The imaging control unit 111A1 controls the cameras C1 to C5 mounted on the multi-eye imaging apparatus 10 and causes each of the cameras C1 to C5 to execute imaging. The imaging includes both capturing a still image and capturing a motion picture. Also, the imaging of a still image includes so-called interval imaging. Interval imaging is a function of repeatedly executing the capturing of the still image at a constant interval. The imaging control unit 111A1 causes each of the cameras C1 to C5 to execute imaging based on an operation input (an instruction to execute imaging) from the input device 115. In the case of capturing a moving image and interval imaging, the imaging is started in response to an instruction to start imaging, and the imaging is ended in response to an instruction to end imaging.

The respective cameras C1 to C5 perform imaging in synchronization. Therefore, in a case of capturing a still image, each of the cameras C1 to C5 captures an image simultaneously (including a range that can be considered to be approximately simultaneously). In addition, in a case of capturing a motion picture, the cameras C1 to C5 start at the same time and end capturing the image at the same time.

The captured image acquisition unit 111A2 acquires images captured by each of the cameras C1 to C5. The images here include not only images that have actually been captured (images obtained in response to an imaging instruction) but also so-called live view images.

The captured image display control unit 111A3 controls the display of images (including live view images) captured by each of the cameras C1 to C5.

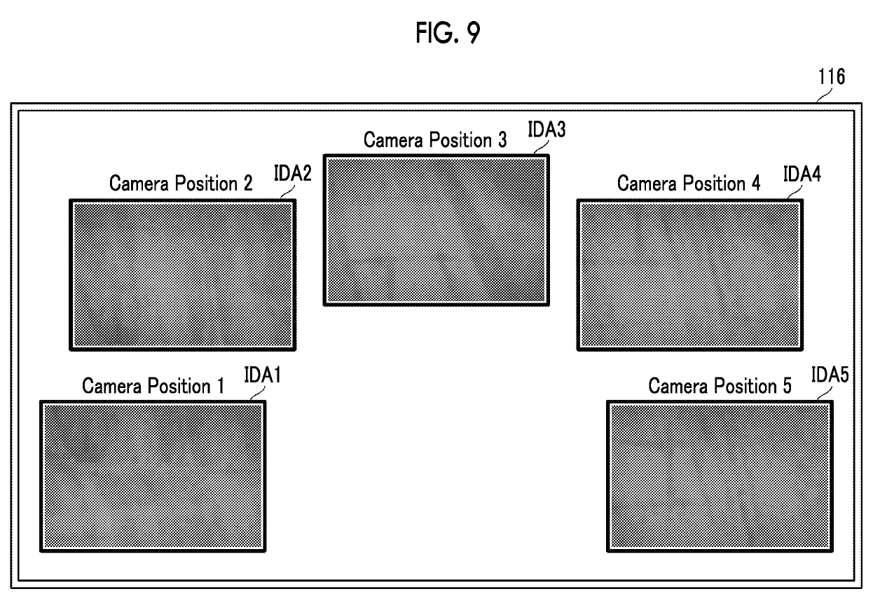

FIG. 9 is a diagram showing an example of a live view display.

As shown in FIG. 9, five image display regions IDA1 to IDA5 are set on the display screen of the display device 116, and live view images from the cameras C1 to C5 are displayed in these regions. The image display regions IDA1 to IDA5 are disposed in a layout corresponding to the disposition of the cameras C1 to C5 in the multi-eye imaging apparatus 10. Therefore, in the present embodiment, the image display regions IDA1 to IDA5 are disposed in an arc shape. In the first image display region IDA1, an image from the first camera C1 is displayed. In the second image display region IDA2, an image from the second camera C2 is displayed. In the third image display region IDA3, an image from the third camera C3 is displayed. In the fourth image display region IDA4, an image from the fourth camera C4 is displayed. In the fifth image display region IDA5, an image from the fifth camera C5 is displayed.

The captured image recording control unit 111A4 controls recording of images captured by each of the cameras C1 to C5. In the present embodiment, the captured image recording control unit 111A4 creates an image database (DB) 120 in the auxiliary storage device 114, and records images captured by each of the cameras C1 to C5 in the image database 120. The images from each of the cameras C1 to C5 are recorded in units of imaging. The imaging for generating one composite image is considered as one unit of imaging. Therefore, for example, in a case of generating a composite image of the entire length of a tunnel, images captured over the entire length of the tunnel structure are recorded as a single group (image group) to be distinguishable from the others. The captured image recording control unit 111A4 records images from each of the cameras C1 to C5 in association with information about the camera that captured the image and information about the order of imaging. That is, the images from each of the cameras C1 to C5 are recorded such that it is possible to distinguish which camera captured the image and in what order. By recording the images in this way, the imaging position of each image can be estimated. That is, the relative positional relationships of each of the cameras C1 to C5 (the disposition of each of the cameras C1 to C5) are known, and the imaging is performed at approximately constant distance intervals. Therefore, in a case in which it is possible to distinguish which camera captured the image and in what order, the approximate imaging position can be specified. For the same reason, the relative positional relationship between the images can also be understood. That is, adjacent images can be specified. Therefore, in the present embodiment, information about the camera that captured the image and information about the order of imaging constitute information about the imaging position of the image.

Note that the information about the “imaging position” does not require the ability to specify an exact geographical position; it is sufficient that it is information that can at least specify the relative positional relationship between the images that constitute the image group, or information that can at least specify adjacent images.

Furthermore, the “information about the camera that captured the image” is information in a case in which the disposition of the camera is known. Therefore, the “information about the camera that captured the image” is synonymous with information about the disposition position of the camera that captured the image (the disposition position on the multi-eye imaging apparatus).

The form of association is not particularly limited. It is only necessary to be able to specify the camera that captured each image and to specify the order in which the images were captured. As an example, in the present embodiment, information about the camera that captured the image and information about the order of imaging are added to the image as additional information (for example, meta information), and the images captured by each of the cameras C1 to C5 are recorded.

The illumination control unit 111B controls the illumination devices L1 to L5 mounted on the multi-eye imaging apparatus 10. That is, on and off of the emission of illumination light from the illumination devices L1 to L5 are controlled. The illumination control unit 111B causes illumination light to be emitted based on an operation input (a turn-on instruction and a turn-off instruction) from the input device 115.

Image Processing Function

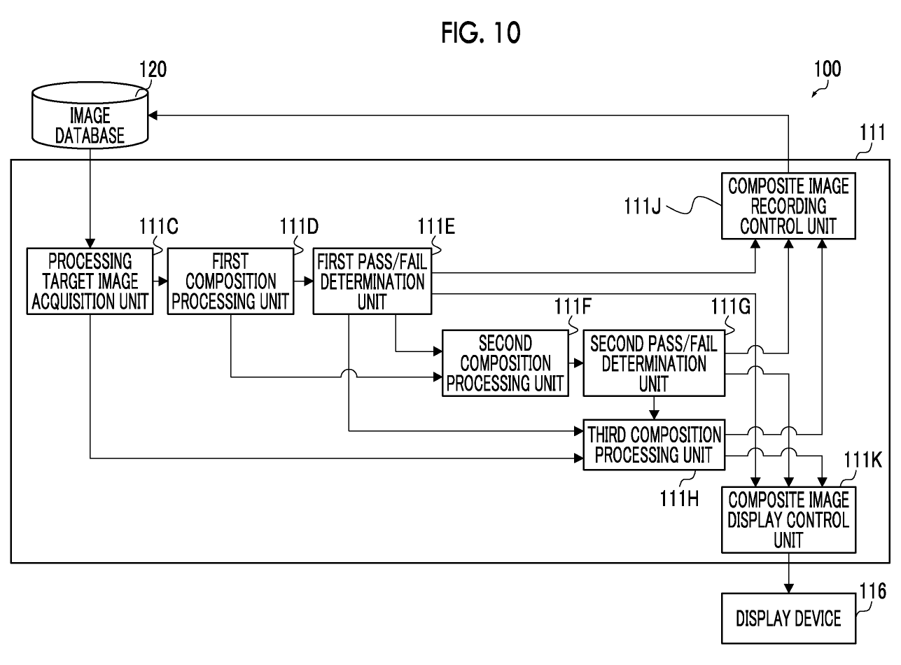

FIG. 10 is a functional block diagram of an image processing function of the control device.

The control device 100 has a function of generating a composite image from an image group captured by the multi-eye imaging apparatus 10 as an image processing function. In the present embodiment, the control device 100 is an example of the image processing apparatus.

As shown in FIG. 10, the control device 100 has, as functions of generating a composite image, functions of a processing target image acquisition unit 111C, a first composition processing unit 111D, a first pass/fail determination unit 111E, a second composition processing unit 111F, a second pass/fail determination unit 111G, a third composition processing unit 111H, a composite image recording control unit 111J, a composite image display control unit 111K, and the like. The functions of each unit are implemented by the CPU 111 executing a predetermined program (image processing program).

### Processing Target Image Acquisition Unit

The processing target image acquisition unit 111C acquires a group of images that is a processing target in the composition process. That is, an image group for generating a composite image is acquired. The processing target image acquisition unit 111C acquires an image group that is a processing target from the image database 120.

As described above, information about the camera that captured the image and the information about the order of imaging are added to the images recorded in the image database 120. From this information, information about the imaging position can be obtained. Therefore, by acquiring the image group that is a processing target, information about the imaging position (approximate imaging position within the tunnel) of each image constituting the image group can be obtained at the same time.

### First Composition Processing Unit

The first composition processing unit 111D performs a predetermined composition process on the image group acquired by the processing target image acquisition unit 111C to generate a composite image. In the present embodiment, a composition process is performed by so-called feature point matching (corresponding point search). Feature point matching (feature matching) is a process of matching feature points that have a high degree of similarity between images. In general, feature points are detected and feature value descriptors are calculated for two images, and feature points with a high degree of similarity are matched.

In the composition process using feature point matching, parameters (composition parameters) required for the composition process are determined from the result of feature point matching, and the composition process is performed based on the determined composition parameters. More specifically, an image is projected onto a shape model based on the determined composition parameters to generate a single composite image.

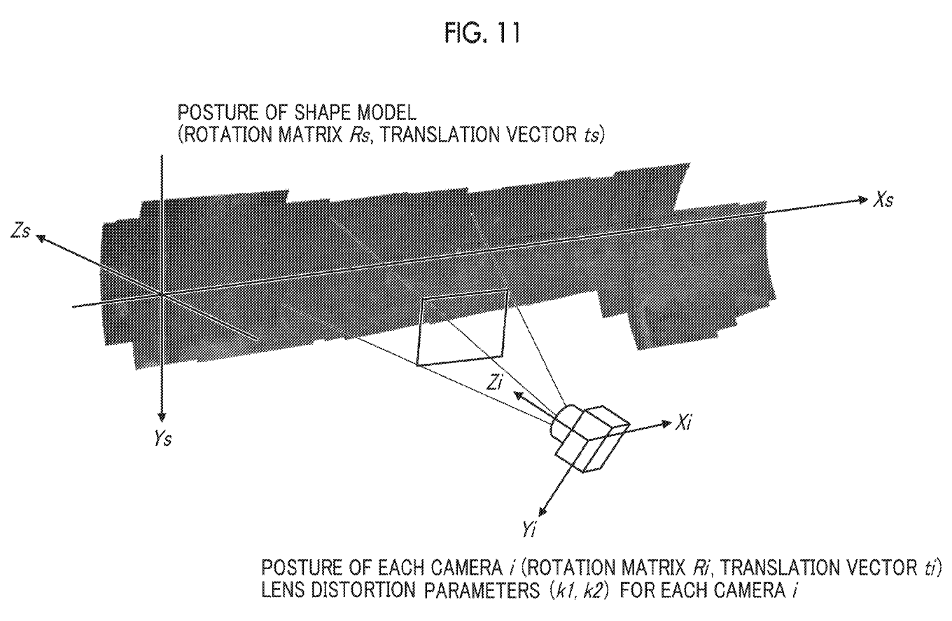

FIG. 11 is a conceptual diagram of a composition process using feature point matching.

In the composition process using feature point matching, the composition parameters are determined from the results of feature point matching between images, including posture parameters of the shape model, posture parameters (a rotation matrix, a translation vector) for each camera corresponding to each image, and lens distortion parameters for each camera corresponding to each image.

The shape model is selected according to the imaging target (the subject). In a case in which the imaging target has a planar surface, a planar model is selected. In the case of a planar model, the rotation matrix and the translation vector are determined as posture parameters. In a case in which the imaging target has a curved surface, a cylindrical model is selected. In the case of a cylindrical model, the rotation matrix, the translation vector, and the radius of the cylinder are determined as posture parameters.

In the case of a tunnel structure whose inner wall surface is arc-shaped (a curved tunnel), a cylindrical model is selected as the shape model. Therefore, in this case, the rotation matrix, the translation vector, and the radius of the cylinder are determined as the posture parameters of the shape model.

The first composition processing unit 111D performs feature point matching between images on the image group acquired by the processing target image acquisition unit 111C, and determines composition parameters from the result of the feature point matching. Furthermore, the first composition processing unit 111D projects an image onto the shape model based on the determined composition parameters to generate a single composite image. Furthermore, in a case in which a cylindrical model is selected as the shape model, the first composition processing unit 111D develops the image projected onto the shape model onto a plane to generate a composite image.

Hereinafter, the composite image generated by the first composition processing unit 111D will be referred to as a “primary composite image” as necessary to distinguish the composite image from other composite images.

In the present embodiment, the composition process using feature point matching performed by the first composition processing unit 111D is an example of a first composition process. In the present embodiment, the composite image (primary composite image) generated by the first composition processing unit 111D is an example of a first composite image.

First Pass/Fail Determination Unit

The first pass/fail determination unit 111E determines whether the composite image (primary composite image) generated by the first composition processing unit 111D passes or fails. In the present embodiment, the pass/fail determination is made based on the quality of the primary composite image. Specifically, in a case in which the quality of the primary composite image satisfies a prescribed quality standard, it is determined to be a pass. Therefore, in a case in which the quality of the primary composite image does not satisfy the prescribed quality standard, it is determined to be a fail.

In the present embodiment, first, the degree of fragmentation of the generated primary composite image is determined, and it is determined whether the quality of the primary composite image satisfies a prescribed quality standard. Second, the degree of distortion of the generated primary composite image is determined, and it is determined whether the quality of the primary composite image satisfies a prescribed quality standard.

Here, “fragmenting the composite image” means that a composite image is generated by dividing it into a plurality of images (fragments).

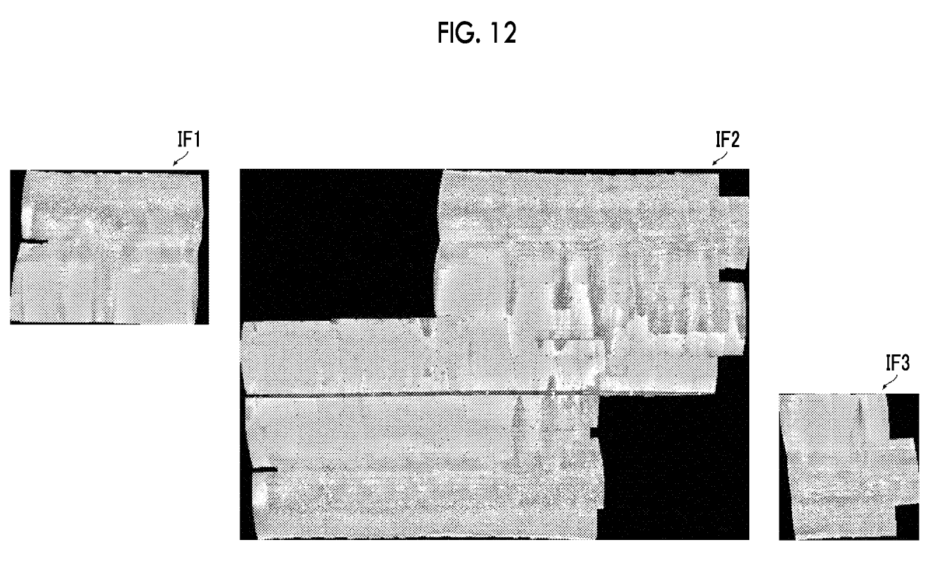

FIG. 12 is a diagram showing an example of a fragmented composite image.

FIG. 12 shows an example of a case in which an image that should have been generated as a single image is separated (fragmented) into three images (fragments) IF1 to IF3.

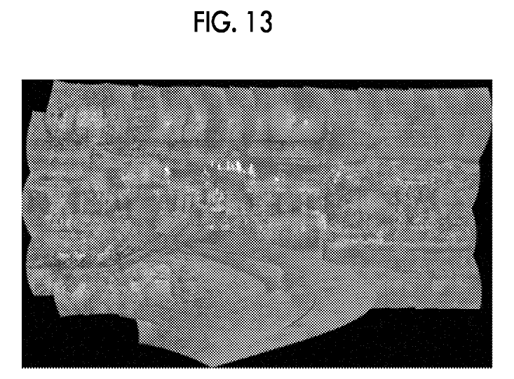

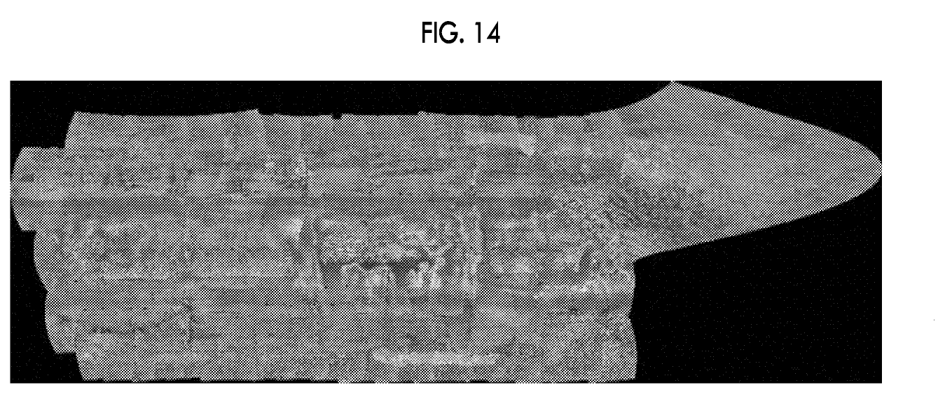

FIGS. 13 and 14 are diagrams showing an example of a composite image in which distortion has occurred.

FIGS. 13 and 14 show cases in which an image that should have been composited as a substantially rectangular image is composited with a portion distorted, as examples. FIG. 13 shows an example of a case in which the central portion of the bottom side of the image is composited in a distorted state. FIG. 14 shows an example of a case in which the upper right corner portion of the image is composited in a distorted state.

Fragmentation, distortion, and the like of the composite image occur due to a failure in the composite process. In compositing images using feature point matching, compositing may fail due to missing or omitted portions during imaging, insufficient overlap between adjacent images, image blur or defocus, or the like, resulting in fragmentation and distortion. Furthermore, in a case in which there are differences in the appearance of the same location between the images in the overlapping region (for example, differences in the way shadows are cast), matching of feature points may not be possible, and composition may fail. Furthermore, composition may fail in a case in which the shape of the object (subject) deviates significantly from the assumed shape model.

1 Pass/Fail Determination Based on Degree of Fragmentation

The first pass/fail determination unit 111E determines the degree of fragmentation of the generated primary composite image, and determines whether the quality of the primary composite image satisfies a prescribed quality standard. That is, it is determined whether the degree of fragmentation satisfies a prescribed standard, and it is determined whether the quality of the primary composite image satisfies a prescribed quality standard. In a case in which the degree of fragmentation satisfies a prescribed standard, it is determined that the quality of the primary composite image satisfies the prescribed quality standard, and the primary composite image is determined to be a pass. On the other hand, in a case in which the degree of fragmentation does not satisfy a prescribed standard, it is determined that the quality of the primary composite image does not satisfy the prescribed quality standard, and the primary composite image is determined to be a fail.

As an example, in the present embodiment, the presence or absence of fragmentation is used as a criterion for determining the “degree of fragmentation”. That is, it is determined whether the quality of the primary composite image satisfies a prescribed quality standard by determining the presence or absence of fragmentation of the primary composite image. Therefore, in a case in which a primary composite image is generated through fragmentation, it is determined that the quality of the primary composite image does not satisfy the prescribed quality standard, and the primary composite image is determined to be a fail. On the other hand, in a case in which the primary composite image is generated as a single composite image without being fragmented, it is determined that the quality of the primary composite image satisfies the prescribed quality standard, and the primary composite image is determined to be a pass.

In the present embodiment, the determination criterion for determining the degree of fragmentation of the generated primary composite image is an example of a first criterion.

2 Pass/Fail Determination Based on Degree of Distortion

The first pass/fail determination unit 111E determines the degree of distortion of the generated primary composite image, and determines whether the quality of the primary composite image satisfies a prescribed quality standard. In a case in which the degree of distortion is within the allowable range, it is determined that the prescribed quality standard is satisfied and the primary composite image is determined to be a pass. On the other hand, in a case in which the degree of distortion exceeds the allowable range, it is determined that the quality does not satisfy the prescribed quality standard, and the primary composite image is determined to be a fail.

As an example, in the present embodiment, the degree of deviation from the image shape that should be generated is calculated to determine the degree of distortion. The “image shape that should be generated” refers to the shape of the image that would be generated in a case in which the composition process was performed normally, and is determined by the imaging range. In imaging structures for inspection, a rectangular cut-out range is generally set as the imaging range (in the case of tunnel structures, a range that is rectangular in the case of being developed onto a plane is set as the imaging range).

In a case in which a tunnel structure is imaged with the multi-eye imaging apparatus 10, the composite image generated through planar development (a normally composited composite image) is an approximately rectangular image. Therefore, the degree of distortion can be determined by calculating the degree of deviation from the rectangle. The degree of deviation from a rectangle can be calculated from the difference between the maximum value and the minimum value of the width of the image in the horizontal direction or the vertical direction. That is, the greater the distortion from the rectangle, the greater the difference, and the degree of distortion can be determined from the difference. In the present embodiment, the difference between the maximum value and the minimum value of the width of the image in the horizontal direction and the difference between the maximum value and the minimum value of the width of the image in the vertical direction are calculated and compared with a threshold value. In a case in which at least one of the differences exceeds a threshold value, it is determined that the distortion is large (the distortion exceeds the allowable range). That is, it is determined that a degree of distortion exceeds the allowable range. Therefore, in the present embodiment, in a case in which the difference between the maximum value and the minimum value of widths in the horizontal direction and the vertical direction of the image is equal to or less than a threshold value, the degree of distortion is determined to be within the allowable range.

FIG. 13 shows an example of a case in which a part (the central portion) of an image is distorted in the vertical direction. In this case, the difference between the maximum value and the minimum value of the width of the image in the vertical direction exceeds a threshold value. FIG. 14 shows an example of a case in which a part of the image (the upper right corner portion) is distorted in the horizontal direction. In this case, the difference between the maximum value and the minimum value of the width in the horizontal direction exceeds a threshold value.

The width of the image is calculated, for example, from the number of pixels. In this case, the difference between the maximum value and the minimum value of the width of the image in the horizontal direction is calculated from the difference between the maximum value and the minimum value of the number of pixels of the image in the horizontal direction. Similarly, the difference between the maximum value and the minimum value of the width of the image in the vertical direction is calculated from the difference between the maximum value and the minimum value of the number of pixels of the image in the vertical direction.

Generally, in generating a composite image, the composite result is shaped into a rectangular image and is output. That is, even in a case in which the composite image is distorted, it is shaped into a rectangular image by so-called padding and is output. Padding is a process of filling with meaningless pixels. For example, in FIGS. 13 and 14, the surrounding black regions are padded regions. FIGS. 13 and 14 show examples of images shaped into a rectangular shape by padding with black pixels.

The “image width” referred to here does not refer to the width of the image after padding, but to the width (the width in the vertical direction and/or the width in the horizontal direction) of the image itself generated by composition. Therefore, for example, for a composite image after padding, it is the width (the width in the vertical direction and/or the width in the horizontal direction) of the region excluding the padding region. In the examples of FIGS. 13 and 14, this is the width of the image region excluding the surrounding black region.

In the present embodiment, the determination criterion for determining the degree of distortion of the generated primary composite image is another example of the first criterion. Furthermore, the measurement direction (the horizontal direction and/or the vertical direction) of the width of the image in calculating the degree of distortion is an example of a first direction.

### Second Composition Processing Unit

The second composition processing unit 111F performs a composition process on the fragmented primary composite image to generate a composite image having a lower degree of fragmentation. Since the target of processing is a fragmented primary composite image, the image that is a processing target by the second composition processing unit 111F is the primary composite image that has been determined to be a fail by the first pass/fail determination unit 111E due to fragmentation.

In the present embodiment, the fragmented primary composite image is composited using information about the imaging position of each image. That is, information about the imaging position (in the present embodiment, information about the camera that captured the image and information about the order of imaging) is used to adjust the disposition positions of a plurality of fragments, and generate a composite image having a lower degree of fragmentation, or more preferably, a single composite image (one composite image).

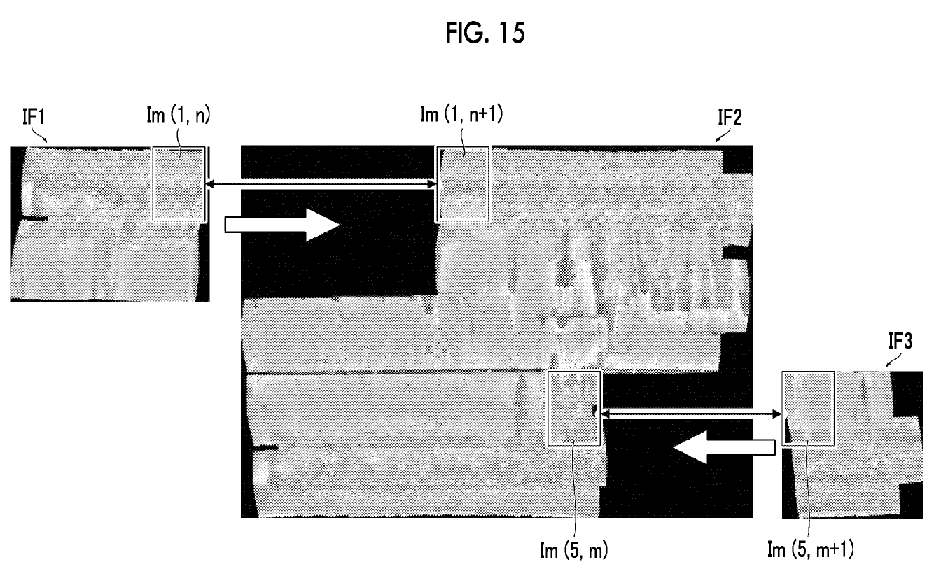

FIG. 15 is a conceptual diagram of a composition process in the second composition processing unit.

FIG. 15 shows an example of a case in which the primary composite image is generated by separating (fragmenting) it into three images (fragments) IF1 to IF3. Hereinafter, as necessary, “image IF1” will be referred to as “first fragment image IF1”, “image IF2” will be referred to as “second fragment image IF2,” and “image IF3” will be referred to as “third fragment image IF3” to distinguish between the images.

As described above, in the image group used to generate the primary composite image, each image has, as information about the imaging position, information about the camera that captured the image, and information about the order of imaging. By having this information about the imaging position, each image constituting the image group can specify its adjacent images. This relationship also applies to a composite image.

First, the relationship between the first fragment image IF1 and the second fragment image IF2 will be considered.

In the first fragment image IF1, an image Im(1, n) that constitutes a part thereof is assumed to be the n-th image captured by the first camera C1. Also, in the second fragment image IF2, an image Im(1, n+1) that constitutes a part thereof is assumed to be the (n+1)-th image captured by the first camera C1.

The image Im(1, n) of the first fragment image IF1 and the image Im(1, n+1) of the second fragment image IF2 are images captured by the same first camera C1. Furthermore, the image Im(1, n+1) of the second fragment image IF2 is the image captured next to the image Im(1, n) of the first fragment image IF1 in time series order. From this, it can be seen that the image Im(1, n) of the first fragment image IF1 is an image that should be disposed to the left of the image Im(1, n+1) of the second fragment image IF2.

Therefore, by disposing the image Im(1, n) of the first fragment image IF1 to be positioned to the left of the image Im(1, n+1) of the second fragment image IF2 and compositing them, the separated state between the first fragment image IF1 and the second fragment image IF2 can be resolved.

Next, the relationship between the second fragment image IF2 and the third fragment image IF3 will be considered.

In the second fragment image IF2, an image Im(5, m) that constitutes a part thereof is assumed to be the m-th image captured by the fifth camera C5. Also, in the third fragment image IF3, an image Im(5, m+1) that constitutes a part thereof is assumed to be the (m+1)-th image captured by the fifth camera C5.

The image Im(5, m) of the second fragment image IF2 and the image Im(5, m+1) of the third fragment image IF3 are images captured by the same fifth camera C5. Furthermore, the image Im(5, m+1) of the third fragment image IF3 is the image captured next to the image Im(5, m) of the second fragment image IF2 in time series order. From this, it can be seen that the image Im(5, m) of the second fragment image IF2 is an image that should be disposed to the left of the image Im(5, m+1) of the third fragment image IF3.

Therefore, by disposing the image Im(5, m) of the second fragment image IF2 to be positioned to the left of the image Im(5, m+1) of the third fragment image IF3 and compositing them, the separated state between the second fragment image IF2 and the third fragment image IF3 can be resolved.

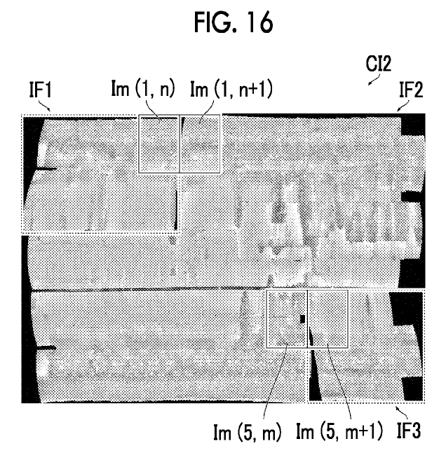

FIG. 16 is a diagram showing an example of a composite result.

In the example shown in FIG. 16, the image Im(1, n) and the image Im(1, n+1) are disposed adjacent to each other, and the first fragment image IF1 and the second fragment image IF2 are composited. Furthermore, the image Im(5, m) and the image Im(5, m+1) are disposed adjacent to each other, and the second fragment image IF2 and the third fragment image IF3 are composited. The generated composite image CI2 is inferior in quality to a normally generated primary composite image but provides an image sufficient for understanding the state of the object (subject).

In the above example, adjacent images are specified using information about the order of imaging (information about the position in the movement direction of the multi-eye imaging apparatus 10), but it is also possible to specify adjacent images using information about the camera that captured the images (information about the disposition position of the camera), or both.

Furthermore, in the above example, the configuration focuses on only one image, specifies adjacent images, and determines the disposition position, but it is also possible to specify the adjacency relationship between a plurality of images and determine the disposition position.

Furthermore, it is preferable that the composite image is generated not by simply disposing the images of the fragments at predetermined positions, but by subjecting the images of the fragments to processing such as enlarging, reducing, or rotating as necessary. These processes are facilitated by specifying the adjacency relationships between a plurality of images and using the results. Therefore, it is preferable to specify the adjacency relationship between a plurality of images to generate a composite image.

In this way, the second composition processing unit 111F uses information about the imaging position of the image to adjust the disposition positions of the fragment images and composite them, thereby resolving fragmentation. By resolving all fragmentation, a single composite image is generated.

In the present embodiment, the composition process performed by the second composition processing unit 111F is an example of a second composition process. In the present embodiment, the composite image generated by the second composition processing unit 111F is an example of a second composite image. Hereinafter, the composite image generated by the second composition processing unit 111F will be referred to as a “secondary composite image” as necessary to distinguish the composite image from other composite images.

Second Pass/Fail Determination Unit

The second pass/fail determination unit 111G determines whether the composite image (secondary composite image) generated by the second composition processing unit 111F passes or fails. In the present embodiment, similarly to the first pass/fail determination unit 111E, pass/fail is determined based on the quality of the secondary composite image. Therefore, the secondary composite image is determined to be a pass only in a case in which the quality of the secondary composite image satisfies the prescribed quality standard (in a case in which the quality of the secondary composite image does not satisfy the prescribed quality standard, it is determined to be a fail).

Similarly to the first pass/fail determination unit 111E, the second pass/fail determination unit 111G first determines the degree of fragmentation of the generated secondary composite image, and determines whether the quality of the secondary composite image satisfies a prescribed quality standard. Second, the degree of distortion of the generated secondary composite image is determined, and it is determined whether the quality of the secondary composite image satisfies a prescribed quality standard.

1 Pass/Fail Determination Based on Degree of Fragmentation

In the present embodiment, whether the prescribed quality standard is satisfied is determined depending on whether fragmentation has been resolved. That is, whether the prescribed quality standard is satisfied is determined depending on whether a single composite image can be generated. In a case in which the second composition processing unit 111F can generate a single composite image, it is determined that the prescribed quality standard is satisfied, and the composition is determined to be a pass. On the other hand, in a case in which the second composition processing unit 111F cannot generate a single composite image, that is, in a case in which composition fails, it is determined that the prescribed quality standard is not satisfied, and the composition is determined to be a fail.

In the present embodiment, the determination criterion for determining the degree of fragmentation of the generated secondary composite image is an example of a second criterion.

2 Pass/Fail Determination Based on Degree of Distortion

The second pass/fail determination unit 111G determines the degree of distortion of the generated secondary composite image, and determines whether the quality of the secondary composite image satisfies a prescribed quality standard. In a case in which the degree of distortion is within the allowable range, it is determined that the quality satisfies the prescribed quality standard and the secondary composite image is determined to be a pass. On the other hand, in a case in which the degree of distortion exceeds the allowable range, it is determined that the quality does not satisfy the prescribed quality standard, and the secondary composite image is determined to be a fail.

Similarly to the first pass/fail determination unit 111E, in the present embodiment, the degree of deviation from the image shape that should be generated is calculated to determine the degree of distortion. Therefore, the difference between the maximum value and the minimum value of the width of the generated secondary composite image in the horizontal direction and the difference between the maximum value and the minimum value of the width of the generated secondary composite image in the vertical direction are calculated to determine the degree of distortion. In a case in which at least one of the differences exceeds the threshold value, it is determined that the distortion is large (the distortion exceeds the allowable range), and the composite image is determined to be a fail.

Note that the “image width” here does not refer to the width of the image after padding, but rather to the width of the image itself generated by composition. That is, the image width is the width of the region excluding the padding region.

### Third Composition Processing Unit

The third composition processing unit 111H generates a composite image of a predetermined format from the image group in a case in which the primary composite image is determined to be a fail because the degree of distortion does not satisfy the prescribed standard, and a case in which the secondary composite image is determined to be a fail. Cases in which a secondary composite image is determined to be a fail include both a case in which the degree of distortion does not satisfy the prescribed standard, and a case in which fragmentation cannot be resolved (a case in which a single composite image cannot be generated).

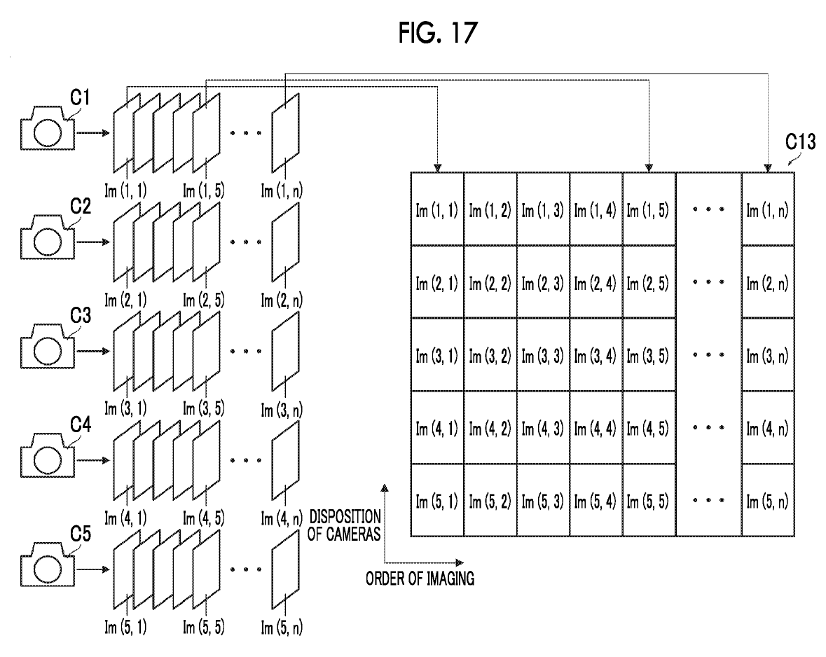

FIG. 17 is a conceptual diagram of generation of a composite image by a third composite processing unit.

The third composition processing unit 111H generates a composite image in which each image constituting the image group is disposed based on information about its imaging position. In the present embodiment, each image is disposed in a predetermined position based on information about the camera that captured the image and information about the order of imaging, and a single composite image is generated. Specifically, the vertical axis (vertical direction) represents the disposition of the cameras that captured the images, and the horizontal axis (horizontal direction) represents the order of imaging by each camera, and the images are disposed in a matrix to generate a single composite image.

As shown in FIG. 17, the images captured by the first camera C1 are assumed to be Im(1, 1), Im(1, 2), Im(1, 3), ..., Im(1, n) in time series order (order of imaging). The images captured by the second camera C2 are assumed to be Im(2, 1), Im(2, 2), Im(2, 3), ..., Im(2, n) in time series order. The images captured by the third camera C3 are assumed to be Im(3, 1), Im(3, 2), Im(3, 3), ..., Im(3, n) in time series order. The images captured by the fourth camera C4 are assumed to be Im(4, 1), Im(4, 2), Im(4, 3), ..., Im(4, n) in time series order. The images captured by the fifth camera C5 are assumed to be Im(5, 1), Im(5, 2), Im(5, 3), ..., Im(5, n) in time series order.

In the composite image IC3, images are generated in which the images captured by the cameras C1 to C5 are arranged in time series order (the order of imaging) in each row. Further, images captured at the same timing by the cameras C1 to C5 are arranged in each column. In other words, in the multi-eye imaging apparatus 10 according to the present embodiment, since each of the cameras C1 to C5 captures images synchronously, in a case in which the images captured by each of the cameras C1 to C5 are arranged in the order of imaging, images captured at the same time point (including substantially the same time point) are arranged in each column.

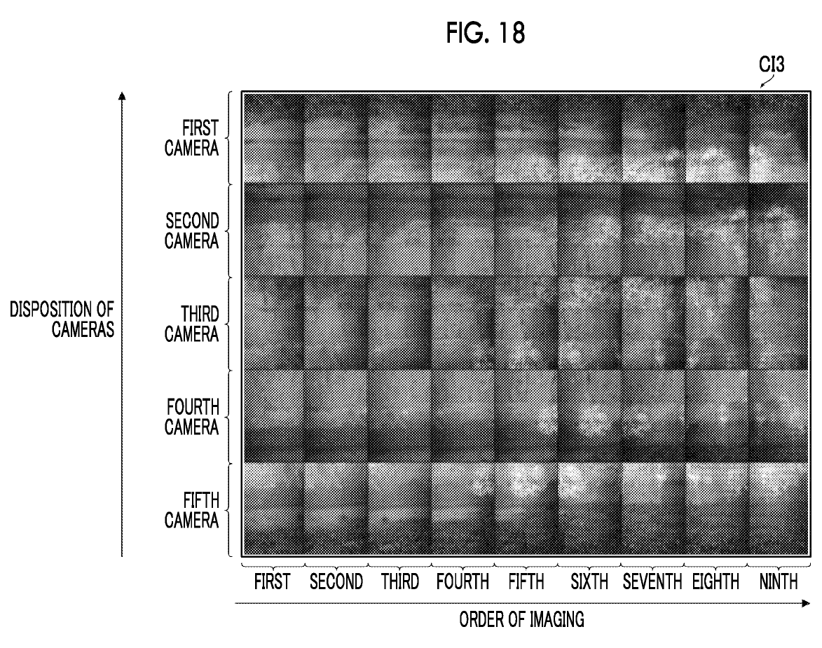

FIG. 18 is a diagram showing an example of the composite image generated by the third composition processing unit.

FIG. 18 shows an example of a composite image CI3 generated from images obtained by performing interval imaging while moving at a substantially constant speed inside a tunnel structure. In particular, FIG. 18 shows an example of a case in which five cameras C1 to C5 capture images nine times. In this case, a single composite image CI3 is generated from an image group consisting of 5 × 9 = 45 images.

As shown in FIG. 18, the generated composite image CI3 has the images captured by the cameras C1 to C5 disposed in the order of imaging in each row. In addition, images captured by the cameras C1 to C5 in the same order (images captured at the same timing) are disposed in each column.

In this way, the third composition processing unit 111H disposes each image constituting the image group in a predetermined array based on information about the imaging position (in the present embodiment, information about the camera that captured the images and information about the order of imaging), and generates a single composite image CI3. Hereinafter, the composite image CI3 generated by the third composition processing unit 111H will be referred to as a “juxtaposed composite image” as necessary to distinguish the composite image from other composite images. The juxtaposed composite image CI3 is inferior in quality to a normally generated primary composite image, but provides an image sufficient for understanding the state of the object (subject). In the present embodiment, the “juxtaposed composite image” is an example of a second composite image.

In the present embodiment, one of a primary composite image, a secondary composite image, or a juxtaposed composite image is generated from the image group.

### Composite Image Recording Control Unit

The composite image recording control unit 111J controls the recording of the generated composite images (the primary composite image, the secondary composite image, and the juxtaposed composite image). The composite image recording control unit 111J records the generated composite image in the image database 120 in association with the image group from which the image was generated. The composite image recording control unit 111J records the generated composite image in the image database 120 automatically or in response to a recording instruction from a user.

### Composite Image Display Control Unit

The composite image display control unit 111K controls the display of the generated composite images (the primary composite image, the secondary composite image, and the juxtaposed composite image). The composite image display control unit 111K displays the generated composite image on the display device 116. The composite image display control unit 111K displays the composite image displayed on the display device 116 by enlarging, reducing, moving, or otherwise manipulating the composite image in response to an instruction from the user.

### Operation of Imaging System

Here, a case in which the inner wall surface of a tunnel structure is subjected to divided imaging by the multi-eye imaging apparatus 10, and a composite image of the inner wall surface of the tunnel structure is generated from the obtained image group will be described as an example.

The imaging is performed by moving the multi-eye imaging apparatus 10 on the carriage Tr. As an example, the carriage Tr is moved at a substantially constant speed and interval imaging is performed to image the inner wall surface of the tunnel structure. At this time, the traveling speed of the carriage Tr and the imaging interval in the interval imaging are set such that the overlap rate of the images in the movement direction of the carriage Tr satisfies a prescribed condition. The condition of the overlap rate is determined from the viewpoint of the composition process. As an example, the condition of the overlap rate is 10% or more. Therefore, the traveling speed of the carriage Tr and the imaging interval in the interval imaging are set such that the overlap rate is at least 10% or more.

The image group obtained by imaging is recorded in the image database 120 in units of imaging such that the image group can be distinguished from an image group obtained by other imaging. Each image constituting the image group is associated with information about the imaging position (in the present embodiment, information about the camera that captured the image and information about the order of imaging), and is recorded in the image database 120.

After the image is captured, a composite image is generated in response to an instruction from the user. In the imaging system 1 according to the present embodiment, the control device 100 performs a process of generating a composite image. More specifically, the CPU 111 of the control device 100 performs a process of generating a composite image from an image group obtained by imaging.

### Process of Generating Composite Image

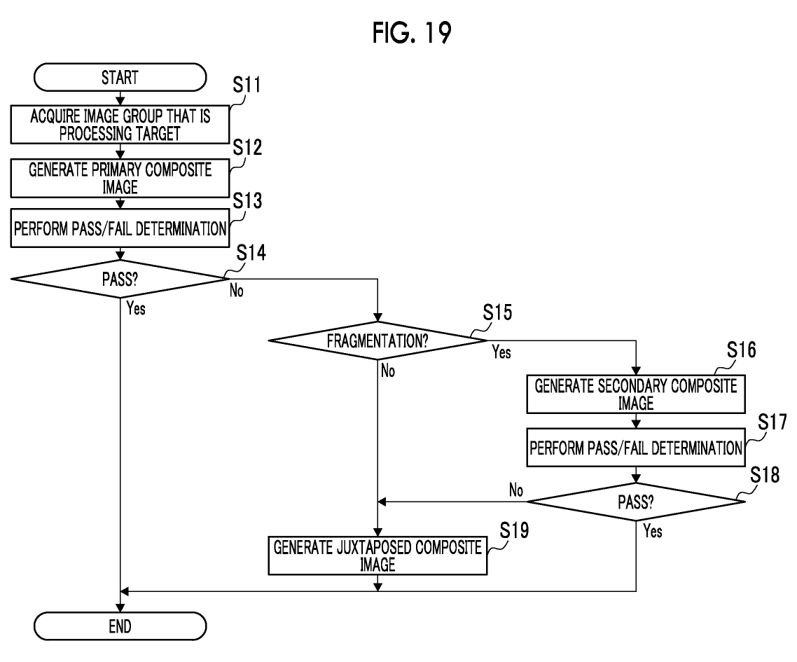

FIG. 19 is a flowchart showing a procedure of a process of generating a composite image (an image processing method).

First, an image group that is a processing target is acquired (Step S11). As described above, in the imaging system 1 according to the present embodiment, an image group obtained by imaging is recorded in the image database 120. The CPU 111 acquires an image group that is a processing target from the image database 120.

Next, a process of generating a primary composite image is performed (Step S12). In the present embodiment, a composition process using feature point matching is performed on the acquired image group to generate a primary composite image.

Next, the generated primary composite image is subjected to a pass/fail determination process (a first pass/fail determination process) (Step S13). In the present embodiment, pass/fail is determined by determining whether the quality of the primary composite image satisfies a prescribed quality standard. Specifically, first, the degree of fragmentation is determined to determine the quality of the image, and then the pass/fail of the image is determined. Second, the degree of distortion is determined to determine the quality of the image and determine whether it passes or fails. In the present embodiment, in a case in which the image is not fragmented and the distortion is within an allowable range, it is determined to be a pass.

Next, based on the result of the pass/fail determination process, it is determined whether the primary composite image passes or fails (Step S14). That is, it is determined whether the composition process (composition process using feature point matching) has been successful. In a case in which the primary composite image is determined to be “pass” as a result of the pass/fail determination, the composition process ends. In this case, the primary composite image is used as an image resulting from the composite process.

On the other hand, in a case in which the primary composite image is determined to be “fail” as a result of the pass/fail determination, the reason for this is discriminated. That is, whether the image has failed due to fragmentation is determined (Step S15).

In a case in which the image is determined to be a fail due to fragmentation, a process of generating a secondary composite image from the fragmented primary composite image is performed (Step S16). Specifically, the disposition position of a plurality of fragments is adjusted using the information about the imaging position of each image, and a composite image (preferably a single composite image) having a lower degree of fragmentation is generated (see FIG. 16).

In a case in which the secondary composite image is generated, the generated secondary composite image is subjected to a pass/fail determination process (a second pass/fail determination process) (Step S17). In the present embodiment, similarly to the pass/fail determination process for the primary composite image (the first pass/fail determination process), it is determined whether the quality of the generated secondary composite image satisfies a prescribed quality standard, and the pass/fail determination is made. Then, based on the result of the pass/fail determination process, it is determined whether the secondary composite image passes or fails (Step S18). That is, it is determined whether the composition process (composition process by adjusting the disposition position based on the information about the imaging position) has been successful. In a case in which the secondary composite image is determined to be “pass” as a result of the pass/fail determination, the composition process ends. In this case, the secondary composite image is used as an image resulting from the composite process.

In a case in which the secondary composite image is determined to be a fail (in a case in which Step S18 is “No”), and in a case in which the primary composite image is determined to be a fail due to distortion (in a case in which Step S15 is “No”), a process of generating a juxtaposed composite image is performed (Step S19). That is, the images constituting the image group are disposed side by side based on the information about their imaging positions to generate one composite image (see FIG. 18). In a case in which a juxtaposed composite image is generated, the juxtaposed composite image is used as the image resulting from the composition process.

The process of generating a composite image is completed through the above series of steps. As described above, in a case in which the generation of the primary composite image is successful (in a case in which the primary composite image passes), the primary composite image is used as the image resulting from the composition process. Furthermore, in a case in which the generation of the primary composite image fails but the generation of the secondary composite image is successful (in a case in which the secondary composite image passes), the secondary composite image is used as the image resulting from the composition process. In a case in which the generation of any of the composite images fails, the juxtaposed composite image is used as the image resulting from the composite process. Therefore, a single composite image is always generated.

In this way, with the control device 100 according to the present embodiment, even in a case in which generation of a primary composite image fails, a single composite image can always be generated. The composite images (secondary composite images and juxtaposed composite images) generated in a case in which the generation of the primary composite image fails are of inferior quality compared to a normally generated primary composite image (a composite image that is successfully generated), but they provide an image sufficient to understand the state of the object (subject) (see FIGS. 16 and 18).

The generated composite images (the primary composite image, the secondary composite image, and the juxtaposed composite image) are displayed on the display device 116. The generated composite image is recorded in the image database 120 automatically or in response to a recording instruction from a user.

### Modification Example

### Generation of Primary Composite Image

In the above embodiment, the configuration is employed in which the primary composite image is generated by a composition process using feature point matching, but the method for generating the primary composite image is not limited thereto. Other techniques (so-called panoramic composition techniques) may also be used for generation.

Furthermore, it is preferable to set the composition parameters appropriately according to the imaging target and the like. For example, in the case of plane composition, which targets a plane, the projective transformation matrix of each image can be used as the composition parameter.

### Information About Imaging Position

In the above embodiment, the information about the imaging position is configured to acquire information about the camera that captured the image (information about the disposition position on the multi-eye imaging apparatus) and information about the order of imaging, but the information acquired as the information about the imaging position is not limited thereto.

As described above, it is sufficient that the information about the “imaging position” is information that can at least specify the relative positional relationship between the images that constitute the image group, or information that can at least specify adjacent images.

For example, in a case in which the cameras C1 to C5 have a global positioning system (GPS) function or an indoor messaging system (IMES) function as an indoor GPS, the GPS function or the IMES function may be used to acquire information about the imaging position. In this case, GPS or IMES position information (latitude, longitude, and altitude) is added to the captured image and recorded (for example, recorded as tag information).

The GPS function or the IMES function may be provided in the multi-eye imaging apparatus 10 or the carriage Tr. In a case in which each camera has a GPS function or an IMES function, the information about the disposition position of the camera can be omitted. This is because the position where the image was captured can be specified using position information from GPS or IMES.

Furthermore, in a case in which information about the order of imaging is used as information about the imaging position, the information about the order of imaging can be configured to be acquired indirectly from other information. For example, in a case of recording an image by adding information about the imaging date and time (a so-called timestamp) as additional information (such as tag information), the order in which the images were captured can be determined from the information about the imaging date and time, and information about the order of imaging can be acquired. Also, for example, in a case in which images are recorded by assigning consecutive file names (in a case in which the number included in the file name is incremented by 1 each time an image is recorded), the order in which the images were captured can be determined from the file names, and information about the order of imaging can be acquired.

Furthermore, for example, in a case in which the carriage Tr is equipped with an odometer or the like, the distance information (distance information from a reference point) obtained from the odometer can be used to acquire information about the imaging position (information about the distance from the reference point or position coordinates). In this case, distance information at the timing of imaging is acquired from the odometer and recorded in association with the image. The reference point is, for example, a position where imaging starts (a position where the carriage starts moving).

### Feature Point Matching

As described above, in the composition process using feature point matching, feature point matching is performed as a pre-processing step for composition (a process required to determine composition parameters).

In general, feature point matching is performed comprehensively between all images that constitute an image group. In a case in which feature point matching is performed comprehensively between all images, the number of feature points that are candidates for matching increases, and the probability of erroneously matching similar feature points increases.

Basically, it is sufficient to perform feature point matching between images that have been captured in an overlapping manner (between images having overlapping regions). Then, by limiting the targets for feature point matching to these images, the probability of erroneous matching can be reduced.

In the imaging system 1 according to the above embodiment, each image constituting an image group has information about the imaging position, and therefore images that have been captured in an overlapping manner can be specified. Therefore, in performing feature point matching, information about the imaging position is used to specify images that have been captured in an overlapping manner. Then, feature point matching is performed only between the specified images. Accordingly, erroneous matching can be suppressed. Furthermore, by reducing the number of processing targets, the processing load of operations can also be reduced.

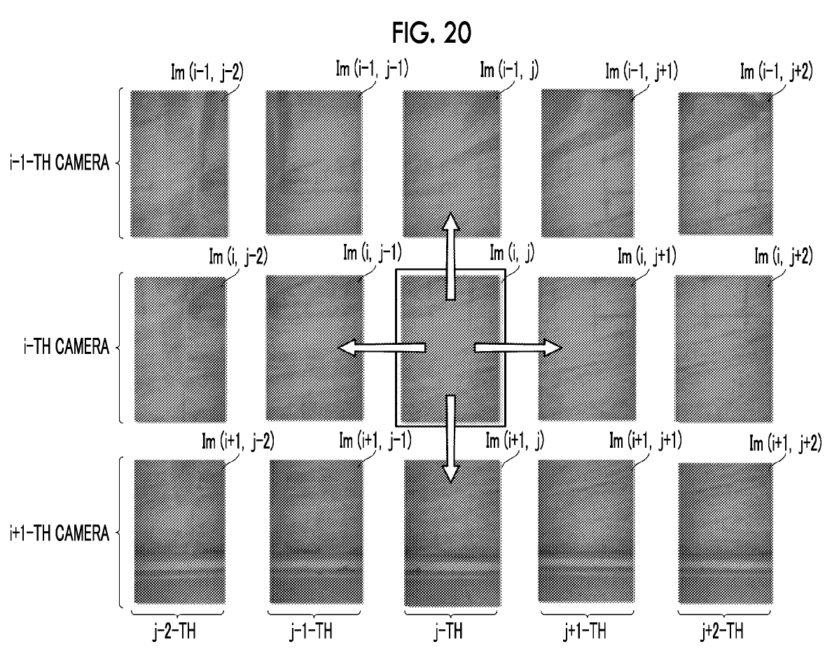

FIG. 20 is a conceptual diagram of a method for specifying images that have been captured in an overlapping manner.

FIG. 20 is a diagram in which a part of an image group captured by the multi-eye imaging apparatus is disposed side by side based on the imaging position. The arrangement in the vertical direction corresponds to the disposition position of each camera. The arrangement in the horizontal direction corresponds to the time series of imaging (the order of imaging).

In FIG. 20, the image of interest is assumed to be the image Im(i, j). The image Im(i, j) is a j-th image captured by an i-th camera. Assuming that each image is captured normally, at least the next four images are images that have been captured in overlap with the image Im(i, j). The first image is an image Im(i, j-1) captured by the i-th camera immediately before the image Im(i, j). The second image is an image Im(i, j+1) captured by the i-th camera immediately after the image Im(i, j). The third image is an image Im(i-1, j) captured by an i-1-th camera adjacent to the i-th camera at the same timing as the image Im(i, j). The fourth image is an image Im(i, j+1) captured by an i+1-th camera adjacent to the i-th camera at the same timing as the image Im(i, j). These four images are images adjacent to the image Im(i, j).

Each image constituting an image group has information about the imaging position, and therefore, by using the information about the imaging position, adjacent images can be specified.

In this way, information about the imaging position is used to specify images that have been captured in an overlapping manner, and to limit the processing targets in performing feature point matching. Accordingly, erroneous matching can be suppressed.

The range of images that have been captured in an overlapping manner varies depending on the disposition of the cameras and imaging conditions (the movement speed, the imaging interval, and the like). Therefore, it is preferable to determine the range of images that have been captured in an overlapping manner (the range of adjacent images) based on the disposition of the cameras, imaging conditions, and the like. For example, in a case in which there is a prescribed or greater overlapping region (an overlapping region that can be composited) between the image captured two images before the image of interest in time series order (image Im(i, j-2) in FIG. 20) and the image captured two images after the image of interest (image Im(i, j+2) in FIG. 20), it is preferable to also subject these images to feature point matching. Furthermore, for example, in a case in which there is a prescribed or greater overlapping region between images captured immediately before and after in time series order by adjacent cameras (images Im(i-1, j-1), Im(i-1, j+1), Im(i+1, j-1), and Im(i+1, j+1) in FIG. 20), it is preferable to also subject these images to feature point matching.

Pass/Fail Determination Based on Distortion

In the above embodiment, the method for determining the degree of distortion is configured to measure the maximum value and the minimum value of the width in the vertical direction and/or the width in the horizontal direction of the generated composite images (the primary composite image and the secondary composite image), and determine whether the degree of distortion is within an allowable range based on whether the difference between the maximum value and the minimum value is equal to or less than a threshold value. The method for determining the degree of distortion is not limited thereto.

1 Method Using Information About Imaging Conditions

The shape of the composite image to be generated can be estimated from the imaging conditions of the image group of the compositing source. For example, in the imaging system 1 according to the above embodiment, in a case in which the object (subject) is imaged by moving the multi-eye imaging apparatus 10 on the carriage Tr, the generated composite image will be rectangular. The size of the image (the width in the vertical direction and the width in the horizontal direction) can also be estimated from the imaging conditions (the imaging resolution, the imaging interval, and the like).

Therefore, the width in the vertical direction and/or the width in the horizontal direction of the composite image to be generated is estimated using information about the imaging conditions, and the degree of distortion is discriminated by comparing with the estimated values.

Specifically, the width in the vertical direction and/or the width in the horizontal direction of the generated composite image is measured and compared with the estimated values of the width in the vertical direction and/or the width in the horizontal direction of the composite image estimated from the imaging conditions. Comparison is performed, for example, by calculating a difference between the measured value and the estimated value. In a case in which the calculated difference is equal to or less than a threshold value, it is determined that the distortion is within the allowable range. That is, a difference equal to or less than the threshold value means that the difference from the estimated shape or width is small, and therefore it can be discriminated that the distortion is small.

Preferably, the width in the vertical direction and the width in the horizontal direction of the generated composite image are measured and compared with the estimated values of the width in the vertical direction and the width in the horizontal direction of the composite image estimated from the imaging conditions. In a case in which the difference between the measured value and the estimated value of the width is equal to or less than a threshold value in both the vertical direction and the horizontal direction, the image is determined to be a pass. For measurement of the width, for example, the number of pixels can be used.

In the present example, information about the imaging conditions is required. The information about the imaging conditions may be configured to be input by the user via the input device 115, for example, or may be configured to be automatically acquired from the camera.

In the present example, the width in the vertical direction and/or the width in the horizontal direction is an example of a width in a second direction.

2 Method Using Composite Parameters

In the composition process based on the composition parameters, the degree of distortion can also be discriminated from the composition parameters. In general, in a case in which there is an image whose composition parameters (camera posture parameters, camera lens distortion parameters) deviate significantly from those of the surrounding images, distortion will occur in the generated composite image. Therefore, by focusing on the composition parameters, it is possible to determine whether there is distortion in the composite image (whether there is distortion exceeding the allowable range). Specifically, after determining composition parameters from the result of feature point matching, it is determined whether there is an image whose composition parameters deviate significantly from those of surrounding images. In a case in which there is no image whose composition parameters deviate significantly from those of the surrounding images, it is determined that the distortion is within the allowable range. On the other hand, in a case in which there is an image whose composition parameters deviate significantly from those of the surrounding images, it is determined that the distortion exceeds the allowable range. Whether an image has composition parameters that deviate significantly from those of surrounding images is determined by calculating the degree of deviation (deviation degree) of the composition parameters between the image and surrounding images (for example, adjacent images) and comparing the calculated deviation degree with a threshold value. In a case in which the deviation degree is equal to or greater than the threshold value, it is determined that the image has composition parameters that deviate significantly from those of the surrounding images.

3 Others

The degree of distortion can also be determined in a composite manner by combining the above-described determination methods. For example, a method for determining by measuring the width of the generated composite image and a method for determining by using a composite parameter can be composited to determine the degree of distortion in a composite manner. In this case, for example, in a case in which all the determinations result in a pass, the image is determined to be a pass.

### Generation of Secondary Composite Image

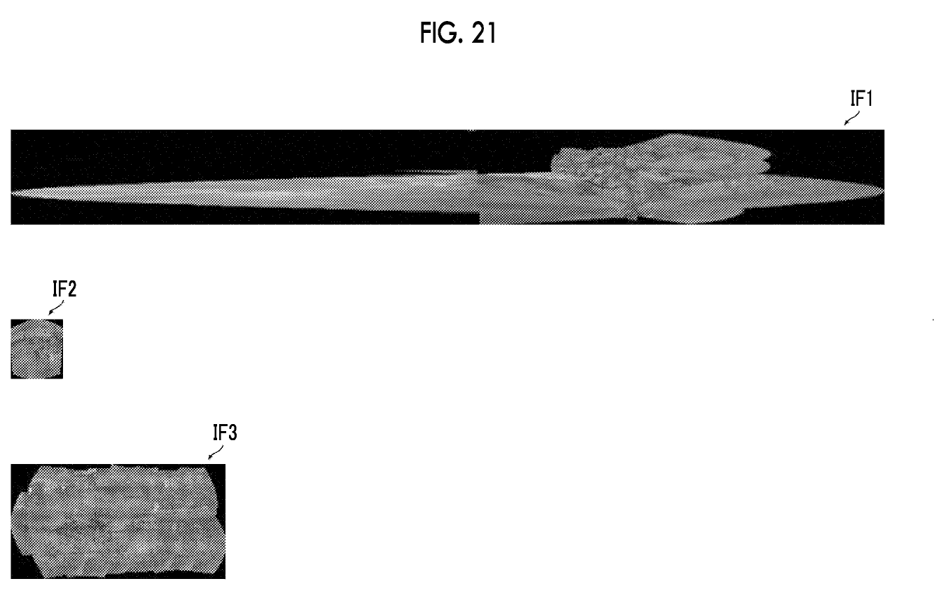

The primary composite image may also be fragmented in a distorted state. FIG. 21 is a diagram showing an example of a primary image that is fragmented in a distorted state. FIG. 21 shows an example of a case in which three images IF1, IF2, and IF3 are fragmented. It is assumed that the image IF1 is a first fragment image IF1, the image IF2 is a second fragment image IF2, and the image IF3 is a third fragment image IF3. Of the three fragment images IF1 to IF3, the first fragment image IF1 is generated with significant distortion. Even in a case in which a primary composite image including such a significantly distorted image is simply disposed based on the information about the imaging position to generate a secondary image, a normal secondary composite image (a secondary composite image that can be determined to be a pass in a pass/fail determination) cannot be generated. Therefore, in a case of generating a secondary composite image from a primary composite image including a significantly distorted image (fragment), it is preferable to correct the distortion before generating the secondary composite image.

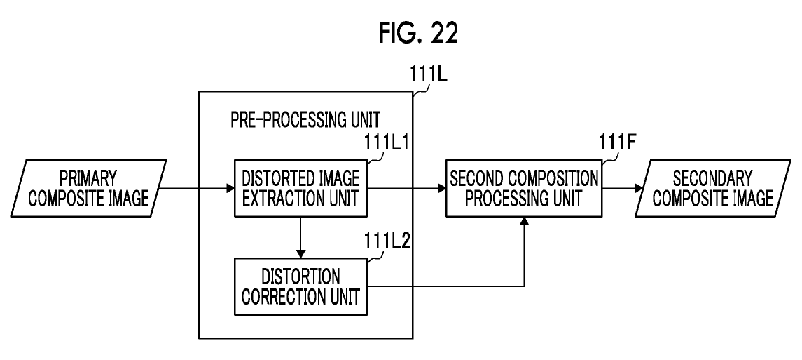

FIG. 22 is a functional block diagram showing an example of a case in which a secondary composite image is generated by correcting distortion.

As shown in FIG. 22, a pre-processing unit 111L is provided in front of the second composition processing unit 111F. The pre-processing unit 111L performs pre-processing on the primary composite image that is a processing target (the fragmented primary composite image) before generating the secondary composite image. The pre-processing unit 111L has functions of a distorted image extraction unit 111L1 and a distortion correction unit 111L2. Each function is implemented by the CPU 111 executing a predetermined program.

The distorted image extraction unit 111L1 detects fragments having distortion exceeding an allowable range from among a plurality of fragments of the fragmented primary composite image. As an example, the distorted image extraction unit 111L1 discriminates the degree of distortion of each fragment based on the composition parameters. Specifically, it is detected whether there is an image in the images that constitute each fragment whose composition parameters deviate significantly from the surrounding images. In a case in which an image is detected in which the composition parameters are significantly different from those of the surrounding images, it is determined that the distortion is large and the distortion exceeds the allowable range. In the present example, a fragment having distortion exceeding the allowable range is an example of a fragment having distortion exceeding a predetermined range.

In a case in which the distorted image extraction unit 111L1 extracts a fragment having distortion exceeding the allowable range, the distortion correction unit 111L2 performs image processing on the fragment to correct the distortion. As an example, the distortion is corrected in the following procedure. First, an image whose composition parameters deviate significantly from those of the surrounding images is specified. Next, the composition parameters of the specified image are corrected to the same as the composition parameters of the surrounding image with less distortion. Accordingly, the distortion occurring in the image of the fragment can be reduced. For distortion correction, other known image processing techniques related to distortion correction can also be employed.

In a case in which distortion correction processing has been performed, the second composition processing unit 111F performs a composition process using the images of the fragments after correction to generate a secondary composite image.

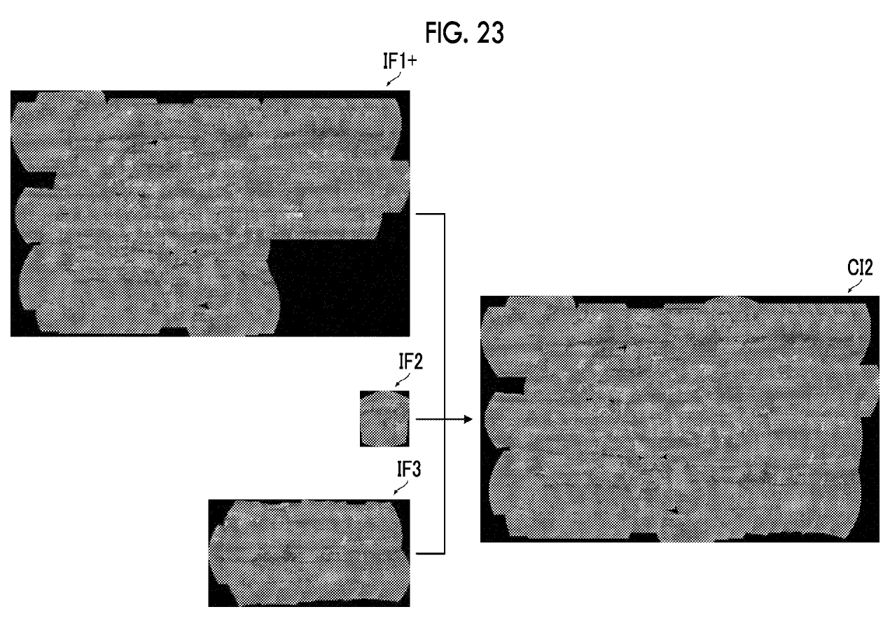

FIG. 23 is a diagram showing an example of a case in which a secondary composite image is generated by performing distortion correction.

FIG. 23 shows an example of a case in which distortion correction is performed on the first fragment image IF1 of the three fragment images IF1 to IF3 shown in FIG. 21 to generate a secondary composite image CI2. In FIG. 23, an image IF1+ is the first fragment image after distortion correction.

In this way, by performing distortion correction on the fragment image generated in a distorted manner to generate a secondary composite image, it is possible to generate a high-quality secondary composite image.

Generation of Juxtaposed Composite Image (1)

In the above embodiment, the images constituting the image group are disposed side by side without overlapping to generate a juxtaposed composite image (see FIGS. 17 and 18), but a configuration may be employed in which the images are disposed in an overlapping manner according to a predetermined disposition rule to generate a single juxtaposed composite image. For example, a configuration can be employed in which adjacent images on the top, bottom, left, and right sides are disposed to be superimposed at a predetermined overlap rate to generate a single juxtaposed composite image. In this case, the overlap rate is set, for example, as follows.

(1) Set to a predetermined value. In this case, for example, the same setting as the overlap rate setting at the time of imaging is used. That is, the overlap rate between the cameras and the overlap rate in the movement direction are set to the same value. For example, in a case in which both images are set to have a 10% overlap rate and are captured, the images are disposed in an overlapping manner such that there is a 10% overlap rate on the top, bottom, left, and right of the image, and a single juxtaposed composite image is generated.

(2) Allow a user to set any overlap rate. In this case, the overlap rate designated by the user is received and a juxtaposed composite image is generated.

(3) The overlap rate is determined based on the information about the imaging position of each image. For example, the overlap rate is determined based on the distance from a reference point or position coordinates.

(4) The overlap rate is determined such that the size of the juxtaposed composite image to be generated is the target size. For example, the overlap rate is determined such that the number of pixels in the vertical direction and the horizontal direction of the juxtaposed composite image to be generated are the target number of pixels, respectively. In this case, the target size may be set by the user as desired. Furthermore, as will be described later, in the case of dividing the imaging target into a plurality of sections to generate a composite image, the target size may be set to be the same size as the composite image (primary composite image) of the section that has been successfully composited. For example, the target size is set to be the same size as a primary composite image of the closest successfully composited section. Also, for example, the target size is set to be the same size as a primary composite image of the adjacent section that has been successfully composited.

Generation of Juxtaposed Composite Image (2)

In the above embodiment, a configuration is employed in which a juxtaposed composite image is generated in a case in which the distortion of the primary composite image exceeds the allowable range and a case in which the secondary composite image fails, but a configuration may be employed in which a juxtaposed composite image is generated in a case in which the primary composite image fails. In this case, in a case in which the generation of the primary composite image fails (in a case in which the primary composite image fails the pass/fail determination), the generation of the secondary composite image is not performed, and a juxtaposed composite image is directly generated.

Generation of Composite Image Divided into Plurality of Parts

In a case of long infrastructure structures such as tunnel structures and bridges, it is not realistic to represent the entire structure in one composite image. Therefore, it is preferable to divide the infrastructure structures into a plurality of sections to generate a composite image for each section. In particular, in the case of long infrastructure structures such as tunnel structures and bridges, it is preferable to divide the infrastructure structures into a plurality of sections along their longitudinal direction to generate a composite image for each section. In this case, for example, the infrastructure structure is divided into a plurality of sections at constant distance intervals along the longitudinal direction, and a composite image is generated for each section.

In a case in which the object is divided into a plurality of sections along the longitudinal direction and a composite image is generated for each section, the imaging operation itself can be completed only once. That is, it is possible to capture images of all sections in one imaging operation. In this case, for example, an image group obtained by imaging each section is extracted from an image group obtained by imaging all sections, and a composite image (a primary composite image, a secondary composite image, or a juxtaposed composite image) of each section is generated using the extracted image group. The image group for each section is extracted using, for example, information about the imaging position.

In this way, in a case in which an object is divided into a plurality of sections and a composite image is generated for each section, an image is generated in which the composite images generated for each section (a primary composite image, a secondary composite image, or a juxtaposed composite image) are disposed based on the arrangement of the sections, and this is used as an overall composite image. For example, in a case in which a tunnel structure is divided into a plurality of sections along the longitudinal direction and a composite image is generated for each section, an image is generated in which the composite images generated for each section (a primary composite image, a secondary composite image, or a juxtaposed composite image) are disposed side by side in a horizontal row, and this is used as an overall composite image. That is, it is used as a composite image of the entire tunnel structure.

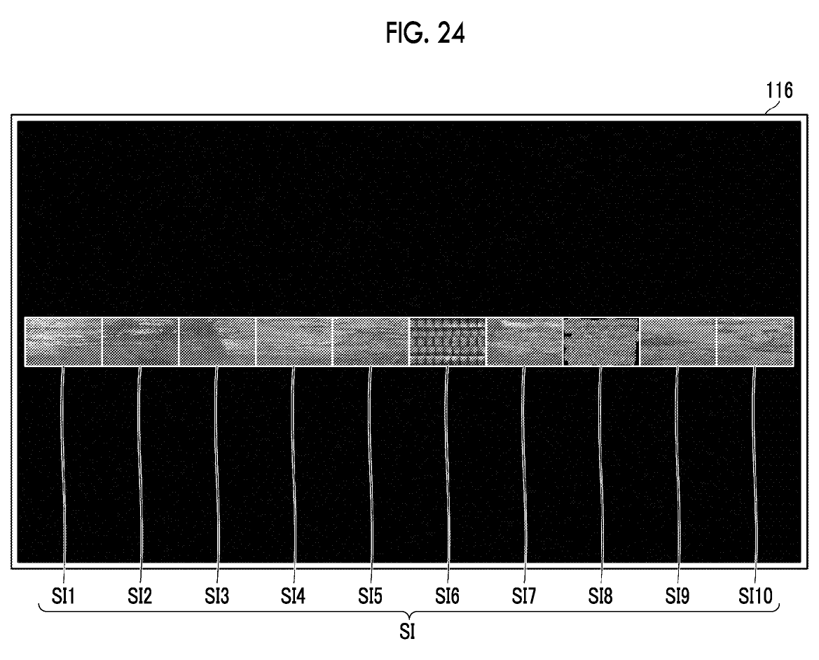

FIG. 24 is a diagram showing an example of a display of a composite result in a case in which a composite image is generated by dividing the image into a plurality of sections.

FIG. 24 shows an example of a case in which a tunnel structure is divided into a plurality of sections (10 sections) at constant distance intervals along the longitudinal direction, and composite images SI1 to SI10 are generated for each section. In this case, as shown in FIG. 24, an image SI is generated in which the composite images SI1 to SI10 generated for each section are arranged in a horizontal row. The generated image SI is displayed on the display device 116 as an image of the entire tunnel structure (entire image).

The composite images SI1 to SI10 are configured by a primary composite image, a secondary composite image, or a juxtaposed composite image. Therefore, even in a case in which a primary composite image cannot be generated in all sections, at least a secondary composite image or a juxtaposed composite image is displayed. Therefore, even in a case in which a normal composite image (primary composite image) cannot be generated due to an omission or the like in imaging in some sections, at the very least, a secondary composite image or a juxtaposed composite image will be displayed. This makes it possible to view the entire infrastructure in an image, even for long infrastructure structures such as tunnel structures and bridges.

In the present example, the image (entire image) SI generated by arranging the composite images SI1 to SI10 in a horizontal row is an example of a first output image. It is preferable that the entire image SI can be displayed by being enlarged or reduced in size in response to an instruction from the user.

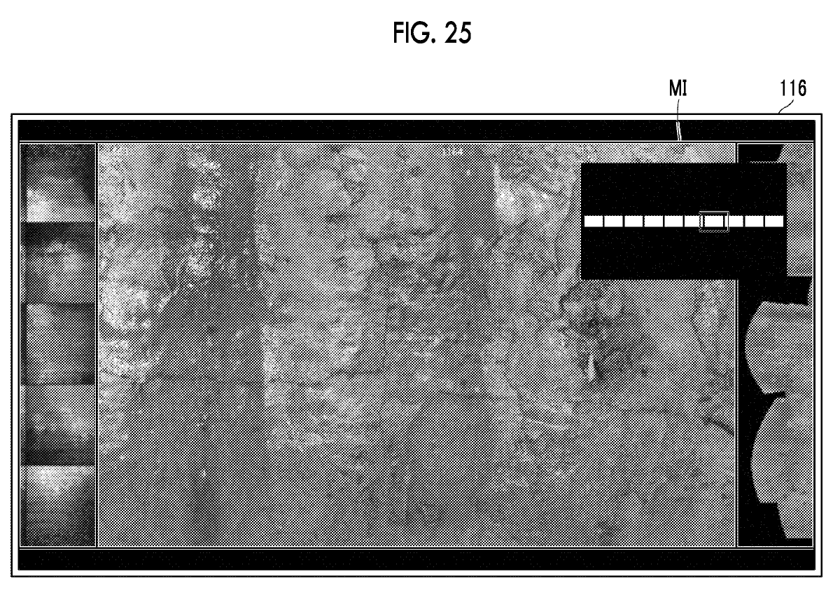

FIG. 25 is a diagram showing an example of a case in which the entire image is enlarged and displayed.

The enlargement/reduction instruction is given, for example, by designating the center point of the enlargement on the entire image SI and inputting the magnification. Alternatively, the center point of the enlargement can be designated on the entire image SI and the mouse wheel can be operated.

In a case in which the image is enlarged, it is preferable to display a reduced version of the entire image SI as a map image MI on the screen, as shown in FIG. 25, so that the enlarged region of the image can be distinguished within the map image MI.

### Damage Detection

Damage (fissuring, peeling, corrosion, and the like) that appears on the surface of the object may be automatically detected from the image, and the results may be displayed together with the composite image.

Damage detection may be performed on the images before composition (the individual images that constitute the image group of the compositing source), or on the image after composition (composite image). The composite images include a secondary composite image, and a juxtaposed composite image in addition to the primary composite image.

The technology for detecting damage from an image is well known, and therefore the details thereof will be omitted. Generally, damage to the surface of an object is detected by analyzing an image obtained by imaging the object. In a case in which the damage is chalked, the chalk lines (for example, lines drawn with chalk along fissuring) are also included in the detection targets.

The damage detection by image analysis includes damage detection using so-called artificial intelligence. As an example, damage detection can be performed using a trained model that has been trained to detect damage from an image.

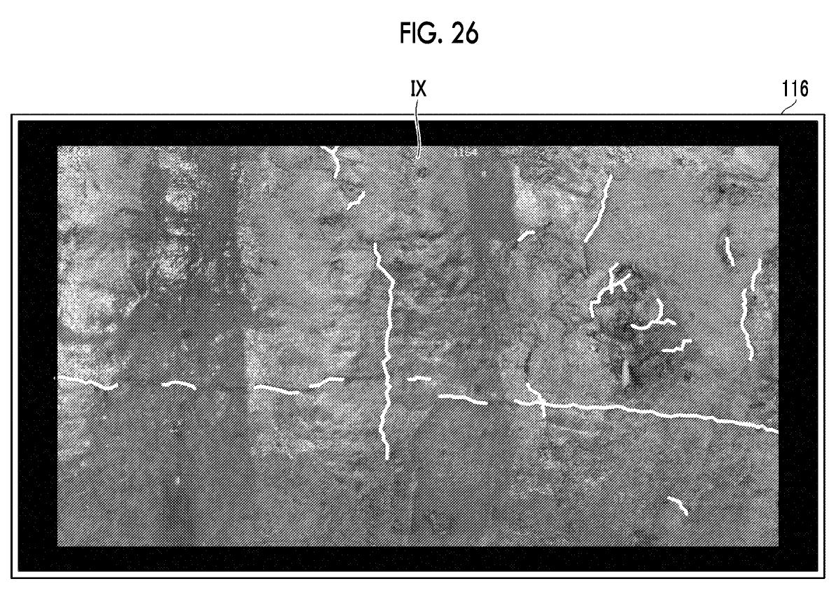

FIG. 26 is a diagram showing an example of a display of a detection result of damage.

An image IX is generated in which the damage detection results are superimposed and displayed on the composite image, and is output to the display device 116. FIG. 26 shows an example of a case in which fissuring is detected as damage. In this case, the image IX is generated in which the lines tracing the detected fissuring are superimposed and displayed on the composite image as the damage detection results.

The display of damage detection results may be turned on or off as desired. For example, in response to an instruction from the user, it is possible to switch between a case of displaying the damage detection results superimposed on the composite image (display on) and a case of not displaying them (display off).

Furthermore, in a case in which a plurality of types of damage are detected, the display may be switched for each type of damage.

Further, the display may be changed depending on the size of the damage such that the size of the damage can be distinguished on the screen. For example, fissuring is displayed in different colors and/or different line types depending on the width of the fissuring. Accordingly, the size (width) of each fissuring can be ascertained at a glance on the screen.

In the present example, the image IX is an example of a second output image.

### Imaging

In the above embodiment, a case in which an object is imaged using a multi-eye imaging apparatus equipped with a plurality of cameras and a composite image is generated has been described as an example, but the method for imaging an object is not limited thereto. For example, an object may be imaged in a divided manner using one camera to acquire an image group to be composited.

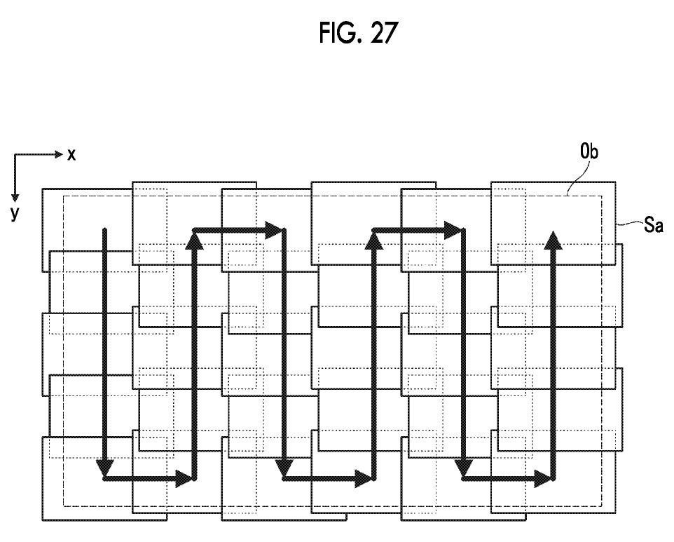

FIG. 27 is a diagram showing an example of a case in which an object is imaged with one camera.

FIG. 27 shows an example of a case in which one region (rectangular region) Ob on a plane is imaged in a divided manner using one camera. In the drawing, reference numeral Sa indicates an imaging region Sa of the camera. As shown in FIG. 27, the position is changed while imaging such that the imaging region Sa overlaps at a predetermined overlap rate (for example, 10% or more) in the vertical direction (y direction), which is a short side direction of the rectangle, and in the horizontal direction (x direction), which is a long side direction of the rectangle. FIG. 27 shows an example of a case in which columns in the vertical direction are imaged one by one in order.

The information about the imaging position is acquired using, for example, a GPS or the like. Furthermore, information about the order of imaging in the vertical direction (y direction) and the horizontal direction (x direction) can be acquired and used as information about the imaging position.

The imaging does not necessarily have to be performed directly by a person, but may be performed by a mobile robot (self-propelled imaging robot). For example, the imaging may be performed using a drone (unmanned aerial vehicle) equipped with a camera. In a case of imaging using a drone or the like, the drone may be moved along a pre-set route and the imaging may be performed automatically.

### Imaging System

In the above embodiment, the image processing function such as generating a composite image is provided in the control device 100, but the image processing function may be implemented by a device separate from the control device 100. For example, a computer (server) on the network may be provided with the image processing function. In this case, the image group that is a processing target is transmitted to a computer on the network, and image processing such as a composition process is performed by the computer on the network.

### Hardware Configuration

The hardware that realizes the image processing apparatus according to the embodiment of the present invention can be configured by various processors. The various processors include, for example, a central processing unit (CPU) which is a general-purpose processor that executes a program to function as various processing units, a programmable logic device (PLD) which is a processor whose circuit configuration can be changed after manufacturing such as a field-programmable gate array (FPGA), and a dedicated electrical circuit which is a processor having a circuit configuration specifically designed to execute specific processing such as an application-specific integrated circuit (ASIC). One processing unit constituting the image processing apparatus may be configured of one of the various processors or may be configured of two or more processors of the same type or different types. For example, one processing unit may be configured by a plurality of FPGAs or a combination of a CPU and an FPGA. In addition, a plurality of processing units may be configured by one processor. As an example in which the plurality of processing units are configured of one processor, first, as typified by a computer such as a client or a server, there is a form in which one processor is configured by a combination of one or more CPUs and software and this processor functions as a plurality of processing units. Second, as represented by a system-on-chip (SoC) or the like, there is a form in which a processor that implements functions of the entire system including a plurality of processing units with a single integrated circuit (IC) chip is used. As described above, the various processing units are configured using one or more of the various processors as a hardware structure. Furthermore, the hardware structure of those various processors is more specifically an electrical circuit (circuitry) in which circuit elements such as semiconductor elements are combined.

### EXPLANATION OF REFERENCES

1: imaging system

10: multi-eye imaging apparatus

11: frame

12: base plate

13: column

14: attachment base

20: relay device

100: control device

111: CPU

111A: camera control unit

111A1: imaging control unit

111A2: captured image acquisition unit

111A3: captured image display control unit

111A4: captured image recording control unit

111B: illumination control unit

111C: processing target image acquisition unit

111D: first composition processing unit

111E: first pass/fail determination unit

111F: second composition processing unit

111G: second pass/fail determination unit

111H: third composition processing unit

111J: composite image recording control unit

111K: composite image display control unit

111L: pre-processing unit

111L1: distorted image extraction unit

111L2: distortion correction unit

112: ROM

113: RAM

114: auxiliary storage device

115: input device

116: display device

117: communication interface

120: image database

Ax: axis

B1: bracket (first bracket)

B2: bracket (second bracket)

B3: bracket (third bracket)

B4: bracket (fourth bracket)

B5: bracket (fifth bracket)

C1: camera (first camera)

C2: camera (second camera)

C3: camera (third camera)

C4: camera (fourth camera)

C5: camera (fifth camera)

CI2: composite image (secondary composite image)

CI3: composite image (juxtaposed composite image)

CL: clamp

IC3: composite image

IDA1: image display region (first image display region)

IDA2: image display region (second image display region)

IDA3: image display region (third image display region)

IDA4: image display region (fourth image display region)

IDA5: image display region (fifth image display region)

IF1: image (first fragment image)

IF2: image (second fragment image)

IF3: image (third fragment image)

IX: image (image in which damage detection results are superimposed and displayed on composite image)

L1: illumination device (first illumination device)

L2: illumination device (second illumination device)

L3: illumination device (third illumination device)

L4: illumination device (fourth illumination device)

L5: illumination device (fifth illumination device)

MI: map image

SI: image (entire image)

SI1: composite image

SI2: composite image

SI3: composite image

SI4: composite image

SI5: composite image

SI6: composite image

SI7: composite image

SI8: composite image

SI9: composite image

SI10: composite image

Sa: imaging region

TS: tunnel structure

Tr: carriage

S11 to S19: procedure of process of generating composite image

What is claimed is:

1. An image processing apparatus comprising a processor,
wherein the processor is configured to:
acquire an image group and information about an imaging position of images constituting the image group;
perform a first composition process on the image group to generate a first composite image;
determine whether a quality of the first composite image satisfies a first criterion; and
perform, in a case in which the quality of the first composite image does not satisfy the first criterion, a second composition process on the image group or the first composite image based on the information about the imaging position to generate a second composite image.

2. The image processing apparatus according to claim 1,
wherein the processor is configured to perform, as the first composition process, a process of performing feature point matching between the images constituting the image group and generating the first composite image from a result of the feature point matching.

3. The image processing apparatus according to claim 2,
wherein the processor is configured to determine a degree of fragmentation of the first composite image to determine whether the quality of the first composite image satisfies the first criterion.

4. The image processing apparatus according to claim 3,
wherein the processor is configured to:
perform, as the second composition process, a process of disposing at least some of a plurality of fragments of the first composite image on fragments different from the fragments based on the information about the imaging position to composite the fragments; and
generate, as the second composite image, an image having a lower degree of fragmentation than the first composite image.

5. The image processing apparatus according to claim 4,
wherein the processor is configured to further perform a process of extracting, from the plurality of fragments, a fragment having distortion exceeding a predetermined range, and correcting the distortion of the extracted fragment having the distortion, before performing the second composition process.

6. The image processing apparatus according to claim 1,
wherein the processor is configured to:
determine whether a quality of the second composite image satisfies a second criterion; and
generate, in a case in which the quality of the second composite image does not satisfy the second criterion, as the second composite image, an image obtained by disposing the images constituting the image group based on the information about the imaging position.

7. The image processing apparatus according to claim 2,
wherein the processor is configured to determine whether a degree of distortion of at least the first composite image is within an allowable range to determine whether the quality of the first composite image satisfies the first criterion.

8. The image processing apparatus according to claim 7,
wherein the processor is configured to perform, as the second composition process, a process of disposing the images constituting the image group based on the information about the imaging position to generate the second composite image.

9. The image processing apparatus according to claim 7,
wherein the processor is configured to:
measure a maximum value and a minimum value of a width of the first composite image in a first direction;
calculate a difference between the maximum value and the minimum value of the width in the first direction; and
determine whether the difference is equal to or less than a threshold value to determine whether the degree of distortion of the first composite image is within the allowable range.

10. The image processing apparatus according to claim 7,
wherein the processor is configured to:
acquire information about an imaging condition of the images constituting the image group;
estimate a width of the first composite image in a second direction based on the information about the imaging condition;
measure the width of the first composite image in the second direction;
calculate a difference between an estimated value and a measured value of the width in the second direction; and
determine whether the difference is equal to or less than a threshold value to determine whether the degree of distortion of the first composite image is within the allowable range.

11. The image processing apparatus according to claim 7,
wherein the processor is configured to:
calculate a deviation degree of composition parameters determined from a result of the feature point matching between adjacent images; and
determine whether there is an image for which the deviation degree is equal to or greater than a threshold value to determine whether the degree of distortion of the first composite image is within the allowable range.

12. The image processing apparatus according to claim 2,
wherein the processor is configured to perform the feature point matching between adjacent images based on the information about the imaging position.

13. The image processing apparatus according to claim 1,
wherein the image group includes images captured at different positions using an imaging apparatus equipped with a plurality of cameras, and
the information about the imaging position includes information about disposition positions of the cameras in the imaging apparatus and information about positions where imaging is performed by the imaging apparatus.

14. The image processing apparatus according to claim 1,
wherein the processor is configured to:
acquire, for an object divided into a plurality of sections in a longitudinal direction, the image group and the information about the imaging position of the images constituting the image group for each section;
generate the first composite image or the second composite image for each section; and
generate a first output image in which the first composite image or the second composite image generated for each section is disposed based on arrangement of the sections.

15. The image processing apparatus according to claim 1,
wherein the processor is configured to:
analyze the images constituting the image group, the first composite image, or the second composite image to detect damage to a surface of an object; and
generate a second output image in which detection results of the damage are superimposed on the first composite image or on the second composite image.

16. An image processing method comprising:
acquiring an image group and information about an imaging position of images constituting the image group;
performing a first composition process on the image group to generate a first composite image;
determining whether a quality of the first composite image satisfies a first criterion; and
performing, in a case in which the quality of the first composite image does not satisfy the first criterion, a second composition process on the image group or the first composite image based on the information about the imaging position to generate a second composite image.

17. A non-transitory, computer-readable tangible recording medium on which an image processing program is recorded, the image processing program causing a computer to implement:
a function of acquiring an image group and information about an imaging position of images constituting the image group;
a function of performing a first composition process on the image group to generate a first composite image;
a function of determining whether a quality of the first composite image satisfies a first criterion; and
a function of performing, in a case in which the quality of the first composite image does not satisfy the first criterion, a second composition process on the image group or the first composite image based on the information about the imaging position to generate a second composite image.
